(19) United States
(12) Patent Application Publication
(10) Pub. No.: US 2023/0039262 A1
(43) Pub. Date: Feb. 9, 2023

(54) PROTOCOL TO INITIATE COMMUNICATION BETWEEN QUANTUM DEVICES CONFIGURED TO SEND OR RECEIVE QUANTUM OBJECTS

(71) Applicant: Voltigeur Networks, Winnipeg (CA)

(72) Inventor: Guillaume Mantelet, Winnipeg (CA)

(21) Appl. No.: 17/786,715

(22) PCT Filed: Feb. 1, 2021
(86) PCT No.: PCT/CA2021/050111

§ 371 Date: Jun. 17, 2022

Related U.S. Application Data
(60) Provisional application No. 62/968,595, filed on Jan. 31, 2020.

(51) Int. Cl. H04L 9/08; H04B 10/70; G06F 21/60

(52) U.S. Cl. CPC H04L 9/0852; H04B 10/70; G06F 21/606

(57) ABSTRACT

Methods for communicating messages encoded in quantum objects comprise exchanging series of values on a classical communication channel between quantum communication devices. Basically, one of the quantum devices discloses a clue on its intention to use a polarization basis for a given quantum object while the other device discloses clue on a basis it will not use in a way similar to the Monty Hall Problem.

### FIELD OF THE INVENTION

The present invention relates to a protocol to initiate communication between quantum devices configured to send or receive quantum objects.

### BACKGROUND

Classical cryptography makes the wish that specifying longer keys to maintain secrecy can deter hackers so long as they do not possess tremendous means and groundbreaking hardware. There are two potential caveats with this approach. First, mathematical problems that form the basis of our secured transmission may or may not have solutions to be discovered. The fact that the absence of proof is not the proof constitutes a sword of Damocles. The rise of quantum computing is a second potential threat. Shor's algorithm is an example that efficiently solves integer factorization—the paragon of classical cryptography.

Quantum cryptography on the contrary, despite being expensive technology, relies on physics, and the sole laws of Nature. To the best of our knowledge, quantum key distribution (QKD) is an efficient mean to achieve secrecy in the clear, that is, where eavesdroppers potentially lurk. Peers in a QKD system use a private channel (quantum channel) to exchange quantum objects, the so-called physic objects that can act as particles and waves at the same time, and that are ruled by the laws of indeterminacy and of superposition of states. State of the art systems use either free space optics or fiber optics for the transmission of photons, for which polarization is a convenient way to carry information. Electrons could be another practical implementation of quantum key distribution systems.

Non orthogonality is the key stone of these systems. Algorithms such as BB84, E91 etc. are well-known methods disclosed that propose a way of exchanging a secret using two (or more) non-orthogonal bases of states, often called rectilinear and diagonal basis, and a basis comprises two polarization states, horizontal and vertical for the rectilinear basis, and diagonal and antidiagonal for the diagonal basis.

The nature of the secret is outside of the scope of this disclosure. The quantum key of QKD systems to be exchanged for further communication encryption is a target case of secret. An encrypted message being transmitted between two quantum devices upon which error correction and tampering detection is being performed is another kind of secret considered indifferently by this disclosure.

The secret is a sequence of classical bits, namely 0 or 1, having a one to one correspondence to a polarization within the basis. For instance, 0 could encode the horizontal state in the rectilinear basis and or the diagonal state in the diagonal basis, and then 1 would encode the vertical state in the rectilinear basis or the antidiagonal state in the diagonal basis.

Thus in commercially available devices, the quantum transmitter generates polarized photons according to the said encoding to the quantum receiver that performs measurement on them, in which it is said that their superposed states “collapse” into a single description depending on the basis it selects randomly. If the measurement basis matches the state of the transmitted photon, then the right classical value it carries can be retrieved. If on the contrary the basis does not match, then quantum indeterminacy occurs and the receiver collects a random state in its basis which ultimately leads to 50% of chance of getting a 0, and 50% of chance of getting a 1. In ideal systems, measurement produces the right value when the correct basis is chosen. If the two quantum devices (peers) have means of comparing their values, for example through a public channel often referred as a classical channel, it means that manipulation by an eavesdropper is observed 50% of the time, when it used the wrong basis . . .

QKD systems also tend to share a public channel to exchange the bases of modulation (e.g. polarization) they respectively used. This helps them isolate when the receiver did not choose the same basis as the transmitter for a particular photon. Relinquishing the basis in the clear is not a concern itself, as it does not provide any clue on the state itself that was measured. By saying that the rectilinear basis was used, we practically cannot deduce if the measured state was horizontal or vertical, thus we cannot determine the corresponding value that was obtained. The quantum devices never exchange the measurement itself for obvious reasons.

The major advantage of QKD compared to classical systems lies in its ability to detect eavesdroppers as they necessarily introduce errors in the legit receiving side. For instance, if it turns out that the receiver did choose the same basis as the transmitter, but the eavesdropper did not, then the eavesdropper may have measured the wrong state, and as such, introduced an error in the receiver sequence of bits. Comparing the level of errors against a threshold helps determining how much information an eavesdropper gained over the secret being exchanged. Other popular solutions consist in sending entangled photons and measuring that the Bell's inequality holds, a proof that no eavesdropper is present on the line.

Practical implementations of these kinds of algorithms rely on passive optical beam splitters in which the process of selecting a basis by the peer systems is left to Mother Nature as a way to reduce the cost of this expensive technology. The abovementioned existing algorithms then assume the loss of 50% of the photons emitted for the sake of framing an eavesdropper, a rate that corresponds to the probability that the quantum transmitter and the quantum receiver do not chose the same basis for a particular photon.

### SUMMARY OF THE INVENTION

According to an aspect of the invention there is provided a method of receiving a message encoded in one or more quantum objects from a transmitting quantum device configured to send the message using a receiving quantum device which is configured to receive the message, wherein there is provided between the transmitting and receiving quantum devices a quantum communication channel for transmitting the quantum objects, each of which are readable using one of a plurality of modulations, and wherein there is provided between the receiving quantum device and a quantum device configured to process the message a classical communication channel for transmitting strings of bits, comprising:

using the receiving quantum device, communicating to said quantum device over the classical communication channel an initial series of values selected from a predefined selection space, the initial series of values being representative of an anticipated series of the modulations to be used by said quantum device to process the quantum objects, the anticipated series of the modulations being based on an initial series of values selected by said quantum device from the predefined selection space, wherein the number of the values in the initial series generated by the receiving quantum device corresponds to the number of the quantum objects forming the message and wherein the number of the values in the predefined selection space is at least three;

after communicating the initial series of values, using the receiving quantum device, receiving from said quantum device over the classical communication channel an eliminative series of values representative of a series of values not selected by either said quantum device or the receiving quantum device, the values in the eliminative series being selected from the predefined selection spaced based on a comparison of the initial series of values generated by said quantum device and the initial series of values generated by the receiving quantum device;

using the receiving quantum device, generating a revised series of values selected from a series of reduced selection spaces, each reduced selection space being formed by removing a corresponding one of the values in the eliminative series from the predefined selection space such that each reduced selection space includes at least two values one of which is a corresponding one of the values in the initial series generated by the receiving quantum device and one of which is a corresponding one of the values in the initial series generated by said quantum device, wherein each value in the revised series is selected by either keeping the corresponding value in the initial series generated by the receiving quantum device or changing to a different value in a corresponding reduced selection space in the series of reduced selection spaces;

using the receiving quantum device, determining a receiving series of the modulations to be used to read the quantum objects based on (i) the revised series of values generated by the receiving quantum device, and (ii) the series of reduced selection spaces; and

using the receiving quantum device, receiving over the quantum communication channel the quantum objects from the transmitting quantum device.

This arrangement provides a method to adapt photon losses due to basis mismatch between the quantum transmitter and the quantum receiver, or between two quantum receivers measuring states over entangled photons. The ability to detect the eavesdropper is traded for an increase in deducing the basis chosen by the peer while randomness is guaranteed. This has the main benefit of reducing the cost per secret bit (OPEX reduction) at the expense of adding random number generators and active polarizers (CAPEX increase).

In one arrangement, said quantum device is the transmitting quantum device.

In another arrangement, said quantum device is a distinct device configured to receive from the transmitting quantum device a common series of the quantum objects as the receiving quantum device.

In one such arrangement, the quantum objects are entangled.

Preferably, in the step of determining the receiving series of the modulations, for each value in the eliminative series designated as a wildcard value by said quantum device, selecting as a corresponding one of the modulations in the receiving series an equally random selection of any one of the modulations such that said corresponding modulation is not based on the revised series of values nor the series of reduced selection spaces.

The method may further include, before generating the initial series of values, using the receiving quantum device, communicating to said quantum device over the classical communication channel (i) a number of the quantum objects which are to form the message to be transmitted over the quantum communication channel, (ii) a size of the predefined selection space, and (iii) a size of the eliminative series.

In one such arrangement, the method further includes, before generating the initial series of values, using the receiving quantum device, communicating to said quantum device over the classical communication channel a revised number of the quantum objects which are to form the message to be transmitted over the quantum communication channel based on a probability received from said quantum device that a value in the eliminative series will be replaced with a wildcard value for which the receiving quantum device is to randomly select any one of the modulations when generating the receiving series of the modulations.

Preferably, in the step of generating the revised series of values, a decision of the receiving quantum device between keeping the corresponding value in the initial series generated by the receiving quantum device, defining a first option, or changing to the different value in a corresponding reduced selection space in the series of reduced selection spaces, defining a second option, is random but has different positive weightings for the first and second options.

The method may further include, after receiving the quantum objects from the transmitting quantum device, using the receiving quantum device, communicating to said quantum device over the classical communication channel a decision series representative of decisions made by the receiving quantum device when generating the revised series of values to either (i) keep the corresponding value in the initial series generated by the receiving quantum device, or (ii) change to the different value in the corresponding reduced selection space in the series of reduced selection spaces.

In one such arrangement, when the eliminative series generated by said quantum device includes at least one wildcard value such that, in the step of determining the receiving series of the modulations, for each wildcard value, the receiving quantum device selects as a corresponding one of the modulations in the receiving series an equally random selection of any one of the modulations such that said corresponding modulation is not based on the revised series of values nor the series of reduced selection spaces, a corresponding one of the decisions in the decision series that is associated with a respective one of the at least one wildcard value of the eliminative series is the corresponding modulation of the receiving series as determined by the receiving quantum device.

The method may further include, after receiving the quantum objects from the transmitting quantum device:

using the receiving quantum device, determining a series of probabilities that an eavesdropping quantum device configured to intercept the quantum objects on the quantum communication channel has selected the modulations of the receiving series, each probability of said series of probabilities being based on a corresponding decision made by the receiving quantum device when generating the revised series of values to either (i) keep the corresponding value in the initial series generated by the receiving quantum device, or (ii) change to the different value in the corresponding reduced selection space in the series of reduced selection spaces; and

using the receiving quantum device, assigning, based on the series of probabilities, each of the modulations in the receiving series to one of a plurality of security-levels including (i) strong, where a corresponding probability in the series of probabilities is equal to about 1/n, and (ii) weak, where a corresponding probability in the series of probabilities is equal to about

$$\frac{n - 1}{n \times m} ,$$

where nis the size of the predefined selection space and m is equal to the size of the eliminative series minus one.

In one such arrangement, assigning each of the modulations in the receiving series to one of the security levels comprises defining a set of security level series, each of the security level series having a length corresponding to the length of the receiving series of the modulations, the set of security level series including:

a first one of the set of security level series comprising values defined at indices therein that correspond to positions of the modulations in the receiving series assigned to the strong security level, and all other indices in the first security level series are undefined; and

a second one of the set of position-identifying series comprising values defined at indices therein that correspond to positions of the modulations in the receiving series assigned to the weak security level, and all other indices in the second security level series are undefined.

In one such arrangement, when the eliminative series generated by said quantum device includes at least one wildcard value such that, in the step of determining the receiving series of the modulations, for each wildcard value, the receiving quantum device selects as a corresponding one of the modulations in the receiving series an equally random selection of any one of the modulations such that said corresponding modulation is not based on the revised series of values nor the series of reduced selection spaces, a corresponding one of the probabilities in said series of probabilities is between a probability associated with the decision to keep the corresponding value in the initial series generated by the receiving quantum device and a probability associated with the decision to change to the different value in the corresponding reduced selection space in the series of reduced selection spaces; and

wherein assigning the modulations in the receiving series to the security levels further includes assigning each modulation associated with a respective one of said at least one wildcard value to one of the security levels of (iii) neutral, where a corresponding probability in the series of probabilities is equal to one divided by a number of the modulations.

In one such arrangement, when assigning each of the modulations in the receiving series to one of the security levels comprises defining a set of security level series, each of the security level series having a length corresponding to the length of the receiving series of the modulations, the set of security level series further includes a third one of the set of security level series comprising values defined at indices therein that correspond to positions of the randomly selected modulations in the receiving series assigned to the neutral security level, and all other indices in the third security level series are undefined.

In such arrangements the method may further include, after receiving the quantum objects from the transmitting quantum device:

using the receiving quantum device, receiving from said quantum device over the classical communication channel an accuracy series generated by said quantum device and representative of correspondence between a series of the modulations applied by said quantum device to process the quantum objects of the message and the receiving series of the modulations used by the receiving quantum device to read the quantum objects of the message, the accuracy series being based on a decision series generated by the receiving quantum device and representative of decisions made by the receiving quantum device when generating the revised series of values to either (i) keep the corresponding value in the initial series generated by the receiving quantum device, or (ii) change to the different value in the corresponding reduced selection space in the series of reduced selection spaces;

using the receiving quantum device, cancelling, based on the accuracy series, respective ones from the receiving series of the modulations where there is no correspondence between the series of the modulations applied by said quantum device and the receiving series, so as to generate a revised receiving series containing only the modulations for which there is correspondence between the series of the modulations applied by said quantum device and the receiving series; and

using the receiving quantum device, detecting errors in the message formed by the quantum objects and read by the receiving quantum device using the same modulations applied by said quantum device.

In one such arrangement the method further includes:

using the receiving quantum device, determining a set of error rates associated with the security levels for detecting presence of an eavesdropping quantum device on the quantum communication channel and interpreting a behaviour of an eavesdropping quantum device which is present;

using the receiving quantum device, comparing each of the set of error rates against a prescribed range of error rate associated with a corresponding one of the security levels, each prescribed range of error rate associated with the corresponding security level having a non-zero minimum error rate which is a difference between a natural error rate representative of error due to noise on the quantum communication channel and a prescribed threshold error rate which is associated with the corresponding security level, and the prescribed range of error rates associated with the corresponding security level having a maximum error rate which is a sum of the natural error rate and the prescribed threshold error rate that is associated with the corresponding security level;

using the receiving quantum device, checking if all of the error rates lie within the associated prescribed ranges of error rate, and
if true then determining that there is no eavesdropping quantum device on the quantum communication channel.

In such arrangements, when a set of error rates associated with the security levels is determined by the receiving quantum device and each of the set of error rates is compared against a prescribed range of error rate associated with a corresponding one of the security levels, each prescribed range of error rate associated with the corresponding security level having a non-zero minimum error rate which is a difference between a natural error rate representative of error due to noise on the quantum communication channel and a prescribed threshold error rate which is associated with the corresponding security level, and the prescribed range of error rates associated with the corresponding security level having a maximum error rate which is a sum of the natural error rate and the prescribed threshold error rate that is associated with the corresponding security level, the method may further include:

using the receiving quantum device, checking if all of the error rates lie below the associated prescribed ranges of error rate, and
if true then determining that there is no eavesdropping quantum device on the quantum communication channel and, for a subsequent message to be sent by the transmitting quantum device, requesting from the said quantum device an increased transmission rate of the message from the transmitting quantum device in which the receiving quantum device decides, at the step of generating the revised series, to more frequently change to the different value instead of keeping the corresponding value in the initial series.

In such arrangements, when a set of error rates associated with the security levels is determined by the receiving quantum device and each of the set of error rates is compared against a prescribed range of error rate associated with a corresponding one of the security levels, each prescribed range of error rate associated with the corresponding security level having a non-zero minimum error rate which is a difference between a natural error rate representative of error due to noise on the quantum communication channel and a prescribed threshold error rate which is associated with the corresponding security level, and the prescribed range of error rates associated with the corresponding security level having a maximum error rate which is a sum of the natural error rate and the prescribed threshold error rate that is associated with the corresponding security level, the method may further include:

using the receiving quantum device, checking if all of the error rates lie above the associated prescribed ranges of error rate, and
if true then determining that there is an eavesdropping quantum device on the quantum communication channel.

In one such arrangement, if it is determined by the receiving quantum device that there is an eavesdropping quantum device, then the method further includes, using the receiving quantum device, requesting from the said quantum device that a subsequent message to be sent by the transmitting quantum device be based on the initial series generated by the receiving quantum device.

In such arrangements, the method may further include:

using the receiving quantum device, checking if the error rate associated with the strong security level lies above the associated prescribed range of error rate and at least one of the error rate associated with the weak security level and the error rate associated with the neutral security level lies below the maximum error rate of the associated prescribed range of error rate corresponding to said at least one of the weak and neutral security levels, and
if true then determining that the eavesdropping quantum device which is present, and which has already intercepted the quantum objects on the quantum communication channel is strategizing to determine the anticipated series of the modulations to be used by said quantum device for a subsequent message to be sent by the transmitting quantum device by deciding to change respective ones of a first series of the modulations generated by the eavesdropping quantum device in an attempt to substantially match the initial series generated by the receiving quantum device, for subsequently reading the quantum objects intercepted on the quantum communication channel.

In one such arrangement, if it is determined by the receiving quantum device that the eavesdropping quantum device is strategizing to determine the anticipated series by deciding to change respective ones of the first series of the modulations generated by the eavesdropping quantum device, then the method further includes, using the receiving quantum device, discarding the received message based on the read quantum objects.

In such arrangements, the method may further include:

using the receiving quantum device, checking if the error rate associated with the weak security level lies above the associated prescribed range of error rate and at least one of the error rate associated with the strong security level and the error rate associated with the neutral security level lies below the maximum error rate of the associated prescribed range of error rate corresponding to said at least one of the strong and neutral security levels, and
if true then determining that the eavesdropping quantum device which is present, and which has already intercepted the quantum objects on the quantum communication channel, is strategizing to determine the anticipated series of the modulations to be used by said quantum device for a subsequent message to be sent by the transmitting quantum device by deciding to keep respective ones of a first series of the modulations generated by the eavesdropping quantum device in an attempt to substantially match the initial series generated by the receiving quantum device, for subsequently reading the quantum objects intercepted on the quantum communication channel.

In one such arrangement, if it is determined by the receiving quantum device that the eavesdropping quantum device is strategizing to determine the anticipated series by deciding to keep respective ones of the first series of the modulations generated by the eavesdropping quantum device, then the method further includes, using the receiving quantum device, discarding that portion of the message corresponding to the modulations assigned to the weak security level.

In such arrangements, when the eliminative series generated by said quantum device includes at least one wildcard value such that, in the step of determining the receiving series of the modulations, for each wildcard value, the receiving quantum device selects as a corresponding one of the modulations in the receiving series an equally random selection of any one of the modulations such that said corresponding modulation is not based on the revised series of values nor the series of reduced selection spaces, a corresponding one of the probabilities in said series of probabilities is between a probability associated with the decision to keep the corresponding value in the initial series generated by the receiving quantum device and a probability associated with the decision to change to the different value in the corresponding reduced selection space in the series of reduced selection spaces, and when assigning the modulations in the receiving series to the security levels further includes assigning each modulation associated with a respective one of said at least one wildcard value to one of the security levels of (iii) neutral, where a corresponding probability in the series of probabilities is equal to one divided by a number of the modulations, the method may further include:

using the receiving quantum device, checking if the error rate associated with the strong security level lies below the associated prescribed range of error rate and the error rate associated with the neutral security level lies within the associated prescribed range of error rate, and
if true then determining that the eavesdropping quantum device which is present, and which has already intercepted the quantum objects on the quantum communication channel, is strategizing to determine the anticipated series of the modulations to be used by said quantum device for a subsequent message to be sent by the transmitting quantum device by deciding to keep or choose, from a first series of the modulations generated by the eavesdropping quantum device in an attempt to substantially match the initial series generated by the receiving quantum device, respective ones of the first series corresponding to said at least one wildcard value, for subsequently reading the quantum objects intercepted on the quantum communication channel.

In one such arrangement, if it is determined by the receiving quantum device that the eavesdropping quantum device is strategizing to determine the anticipated series by deciding to keep or chose respective ones of the first series of the modulations corresponding to said at least one wildcard value, then the method further includes, using the receiving quantum device, discarding at least that portion of the message corresponding to the modulations assigned to the weak and neutral security levels.

According to another aspect of the invention there is provided a method of transmitting a message encoded in one or more bits encoded in quantum objects from a transmitting quantum device configured to send the message and a receiving quantum device configured to receive the message, wherein there is provided between the transmitting and receiving quantum devices (i) a quantum communication channel for transmitting the quantum objects, each of which are formed by encoding one or more of the bits of the message using one of a plurality of modulations, and (ii) a classical communication channel for transmitting strings of bits, comprising:

using the transmitting quantum device, generating, by selecting from a predefined selection space, a master series of values representative of the modulations to be used in forming the quantum objects to be transmitted to the receiving quantum device, wherein the number of the values in the master series corresponds to the number of the quantum objects forming the message to be sent and wherein the number of the values in the predefined selection space is at least three;

using the transmitting quantum device, receiving from the receiving quantum device over the classical communication channel an initial series of values selected by the receiving quantum device from the predefined selection space, the values in the initial series being representative of an anticipated series of the modulations to be used by the transmitting quantum device to generate the quantum objects, wherein the number of the values in the initial series corresponds to the number of the quantum objects forming the message to be sent;

using the transmitting quantum device, generating for subsequent communication to the receiving quantum device an eliminative series of values not selected by either the transmitting quantum device or the receiving quantum device, the values in the eliminative series being selected from the predefined selection spaced based on a comparison of the master series of values generated by the transmitting quantum device and the initial series of values received from the receiving quantum device;

wherein, in the step of generating the eliminative series of values, if any pair of the compared values is the same, then the corresponding value in the eliminative series is an equally random selection of any one of the other values from the predefined selection space;

using the transmitting quantum device, communicating the eliminative series of values to the receiving quantum device over the classical communication channel so as to provide a hint to the receiving quantum device as to the master series of values generated by the transmitting quantum device;

using the transmitting quantum device, determining a transmitting series of the modulations to be used to form the quantum objects based on (i) the master series of values generated by the transmitting quantum device, and (ii) a series of reduced selection spaces, each reduced selection space being formed by removing a corresponding one of the values in the eliminative series from the predefined selection space; and

using the transmitting quantum device, communicating to the receiving quantum device over the quantum communication channel the message encoded in the quantum objects formed by the series of the modulations.

In one example of any of the arrangements described hereinbefore:

the step of generating the eliminative series of values further comprises, for each value in the eliminative series, keeping the value selected from the predefined selection space or replacing said value with a wildcard value; and

in the step of determining the transmitting series of the modulations, for each wildcard value in the eliminative series, selecting as a corresponding one of the modulations in the transmitting series an equally random selection of any one of the modulations such that the corresponding modulator is not based on the master series of values nor the series of reduced selection spaces.

In one such arrangement, in the step of generating the eliminative series of values, a decision of the transmitting quantum device between keeping the value selected from the predefined selection space, defining a first option, or replacing said value with a wildcard value, defining a second option, is random but has different weightings for the first and second options.

In such arrangements the method may further include, before generating the master series of values, using the transmitting quantum device, communicating to the receiving quantum device over the classical communication channel (i) a number of the quantum objects which are to form the message to be transmitted over the quantum communication channel, and (ii) a size of the predefined selection space.

In one such arrangement the method further includes, before generating the master series of values, using the transmitting quantum device, communicating to the receiving quantum device over the classical communication channel a probability of replacing a value in the eliminative series by a wildcard value for which the receiving quantum device is to random select any one of the modulations when receiving a corresponding one of the quantum objects from the transmitting device.

It will be appreciated that features recited in relation to one aspect of the invention may be applicable to and thus used in conjunction with another aspect of the invention.

### BRIEF DESCRIPTION OF THE DRAWINGS

The invention will now be described in conjunction with the accompanying drawings in which:

FIGS. 1 to 7 illustrate schematic diagrams of quantum transmitters and receivers which may employ arrangements of the present invention;

FIG. 8 show a probability distribution during a preprocessing step of an arrangement of the present invention;

FIGS. 9A and 9B show flowcharts of preprocessing steps of prior art and an arrangement of the present invention, respectively;

FIG. 10 is a flowchart of steps of an arrangement of the present invention performed by a quantum receiver and another quantum device; and

FIGS. 11 to 14 illustrate an example of the arrangement of FIG. 10.

In the drawings like characters of reference indicate corresponding parts in the different figures.

### DETAILED DESCRIPTION

With reference to the accompanying figures, there is disclosed herein a protocol for communicating a message encoded in quantum objects including a method of transmitting the quantum objects and a method of receiving the quantum objects.

As described in further detail hereinafter, the present invention relates at least in part to a method of receiving a message encoded in one or more quantum objects from a transmitting quantum device configured to send the message using a receiving quantum device which is configured to receive the message, wherein there is provided between the transmitting and receiving quantum devices a quantum communication channel for transmitting the quantum objects, each of which are readable using one of a plurality of modulations, and wherein there is provided between the receiving quantum device and a quantum device configured to process the message a classical communication channel for transmitting strings of bits, comprising:

using the receiving quantum device, communicating to said quantum device over the classical communication channel an initial series of values selected from a predefined selection space, the initial series of values being representative of an anticipated series of the modulations to be used by said quantum device to process the quantum objects, the anticipated series of the modulations being based on an initial series of values selected by said quantum device from the predefined selection space, wherein the number of the values in the initial series generated by the receiving quantum device corresponds to the number of the quantum objects forming the message and wherein the number of the values in the predefined selection space is at least three;

after communicating the initial series of values, using the receiving quantum device, receiving from said quantum device over the classical communication channel an eliminative series of values representative of a series of values not selected by either said quantum device or the receiving quantum device, the values in the eliminative series being selected from the predefined selection spaced based on a comparison of the initial series of values generated by said quantum device and the initial series of values generated by the receiving quantum device;

using the receiving quantum device, generating a revised series of values selected from a series of reduced selection spaces, each reduced selection space being formed by removing a corresponding one of the values in the eliminative series from the predefined selection space such that each reduced selection space includes at least two values one of which is a corresponding one of the values in the initial series generated by the receiving quantum device and one of which is a corresponding one of the values in the initial series generated by said quantum device, wherein each value in the revised series is selected by either keeping the corresponding value in the initial series generated by the receiving quantum device or changing to a different value in a corresponding reduced selection space in the series of reduced selection spaces;

using the receiving quantum device, determining a receiving series of the modulations to be used to read the quantum objects based on (i) the revised series of values generated by the receiving quantum device, and (ii) the series of reduced selection spaces; and

using the receiving quantum device, receiving over the quantum communication channel the quantum objects from the transmitting quantum device.

Furthermore, as described in further detail hereinafter, the present invention relates at least in part to a method of transmitting a message encoded in one or more bits encoded in quantum objects from a transmitting quantum device configured to send the message and a receiving quantum device configured to receive the message, wherein there is provided between the transmitting and receiving quantum devices (i) a quantum communication channel for transmitting the quantum objects, each of which are formed by encoding one or more of the bits of the message using one of a plurality of modulations, and (ii) a classical communication channel for transmitting strings of bits, comprising:

using the transmitting quantum device, generating, by selecting from a predefined selection space, a master series of values representative of the modulations to be used in forming the quantum objects to be transmitted to the receiving quantum device, wherein the number of the values in the master series corresponds to the number of the quantum objects forming the message to be sent and wherein the number of the values in the predefined selection space is at least three;

using the transmitting quantum device, receiving from the receiving quantum device over the classical communication channel an initial series of values selected by the receiving quantum device from the predefined selection space, the values in the initial series being representative of an anticipated series of the modulations to be used by the transmitting quantum device to generate the quantum objects, wherein the number of the values in the initial series corresponds to the number of the quantum objects forming the message to be sent;

using the transmitting quantum device, generating for subsequent communication to the receiving quantum device an eliminative series of values not selected by either the transmitting quantum device or the receiving quantum device, the values in the eliminative series being selected from the predefined selection spaced based on a comparison of the master series of values generated by the transmitting quantum device and the initial series of values received from the receiving quantum device;

wherein, in the step of generating the eliminative series of values, if any pair of the compared values is the same, then the corresponding value in the eliminative series is an equally random selection of any one of the other values from the predefined selection space;

using the transmitting quantum device, communicating the eliminative series of values to the receiving quantum device over the classical communication channel so as to provide a hint to the receiving quantum device as to the master series of values generated by the transmitting quantum device;

using the transmitting quantum device, determining a transmitting series of the modulations to be used to form the quantum objects based on (i) the master series of values generated by the transmitting quantum device, and (ii) a series of reduced selection spaces, each reduced selection space being formed by removing a corresponding one of the values in the eliminative series from the predefined selection space; and

using the transmitting quantum device, communicating to the receiving quantum device over the quantum communication channel the message encoded in the quantum objects formed by the series of the modulations.

In this protocol or method, one of the quantum devices discloses a clue on its intention to use a non-orthogonal basis for a given quantum object (e.g. rectilinear or diagonal for systems with two basis) while the other device discloses clue on a basis it will not use in a way similar to the Monty Hall Problem, a paradox in game theory and applied in famous tv shows.

In the Monty Hall Problem, a candidate (human) is asked to choose among N options to find a unique concealed prize. N equals three in the corresponding tv show. Should the candidate fails, he or she leaves the game empty-handed. Usually, two steps take place:

The candidate discloses publicly his or her choice among a preselection space of size N.

The presenter then discloses M options that do not conceal the prize, which are options that the presenter did not choose, leaving the candidate with the dilemma of keeping his or her initial choice or changing option among the reduced N−M options left.

The disclosure by the presenter changes the conditions of the problem. It is proven that the options of the dilemma do not hold the same probability of hiding the prize. Instead, the candidate increases his or her chances to earn the prize by discarding the initial choice and changing option.

Table I shows a brute force analysis showing the counter-intuitive concept in action where N=3 and M=1.

To generalize the Monty Hall Problem to N options where N>2, and where the presenter discloses M empty options where N−M>1, it can be demonstrated that the strategy of keeping initial choice is fruitful in

$$\frac{1}{N}$$

of the cases, while changing option leads to the prize in

$$\frac{N - 1}{M} \cdot \frac{1}{N}$$

cases, that is the probability of finding the prize is equally distributed among the remaining options left by the presenter. Table II illustrates the probabilities of finding the prize by changing option.

With existing solutions, probability to select the same basis to retrieve the correct value is shared equally between the available bases. In the case of BB84, this means that half of the secret is measured with the wrong basis, and a quarter of the corresponding bits would be statistically erroneous. Using the previous table, rates can be adjusted, for example, selecting N=8 and M=1 would lead to 1/16of the bits to be erroneous instead.

The disclosure proposes to increase the key rate by offering a strategy that helps a receiver to guess the basis chosen by the transmitter. In this case, occurrence of basis mismatch is decreased and overall key rate is increased.

However, since the QKD devices apply a strategy by using this table, an eavesdropper trying to gain knowledge on the secret will apply the same strategy with the consequence of performing the right measurement at worst, and being unnoticed at best. We discuss a method to guarantee the QKD devices to detect the presence of an eavesdropper despite the application of the Monty Hall Problem.

The architecture of this protocol is overlaid to the existing quantum infrastructure comprising quantum transmitters and quantum receivers and the set of hardware defined in prior art required to exchange a secret on a quantum and a public channel. Prior art refers indifferently to the receiver and the transmitter to exchange information on the public channel without specifying an “initiator” and a “responder” for such exchanges. By convention, we consider here the quantum receiver as the “initiator” of such communications and either the quantum transmitter as being a “responder”, or if an external source of entangled photons is used, one of the quantum receivers is elected “initiator” by classical means of prior art outside of the scope of the disclosure, the other receiver becoming the “responder”. In this disclosure, a quantum receiver is initiating transmissions on the classical channel while a quantum transmitter or another quantum receiver, also called “said quantum device” responds to these requests.

By convention we say that the quantum receiver is the candidate in the Monty Hall Problem and the said quantum device, a quantum transmitter or a second receiver measuring state on an entangled particle, is the presenter. By convention we say that N is the preselection space size and N—M is the reduced selection space, the key rate and the detection rate depends on these two values. The preselection space represent a set of values ranging from 1 to N that will be used to represent the available options to implement the Monty Hall Problem. The problem is being repeated for each of the bits of the secret to be exchanged between the two QKD devices.

Prior art solutions typically rely on two steps where the first step is the “key creation”, the generation and the receiving of quantum objects over the quantum channel, and a second step called “post-processing step” helping the two quantum devices synchronizing their knowledge on the secret, determine if an eavesdropper is present and virtually denying the knowledge of the eavesdropper about the secret. The post-processing step is performed via the classical channel and comprises:

Sifting is the operation in which the quantum devices exchange the basis they used to encode and measure the quantum objects. The quantum devices remove the values corresponding to non-matching basis.

Reconciliation deals with the fact that errors can be introduced even without the presence of an eavesdropper. Noise in photon detectors can introduce errors. Alternatively, single photon sources may generate more than one photon, giving an eavesdropper the opportunity to perform measurements on a copy of a photon while being unnoticed. Reconciliation is the exchange of information on the public channel to check the parity of blocks of the obtained secret to detect the presence of such errors. As information is exchanged, an eavesdropper gains knowledge on the parity of the secret, the quantum devices usually discard the last bit of the secret of each of the block.

Privacy amplification is a technique that reduces the size of the final secret in order to strengthen the security of that secret.

Assuming now the execution of the Monty Hall Problem as clues over the choice of the basis, a preprocessing step is required by the following disclosure in which:

Negotiation (handshake): The quantum devices exchange the conditions of the Monty Hall Problem, the size of the predefined selection space, the dimension of the eliminative series, potentially the size of the secret to be exchanged to check that the probabilities comply with it, and optional rates to defeat side attacks from an eavesdropper.

The said quantum device builds a master series of random values. The size of the predefined selection space may not match the number of non-orthogonal basis of the quantum hardware. In this case, an encoding is required to translate the master series of values and the final choice of the basis (modulation) to encode the quantum objects.

The receiving quantum device generates and discloses an initial series of values selected from the predefined selection space corresponding to an anticipated series of the modulations used by the said quantum devices based on its master series of values.

The said quantum devices then generate an eliminative series of values by disclosing values that will not be chosen to modulate the corresponding quantum object. The quantum receiver is left with either a value of its initial series of values or a set of other values that may or may not include the value of the master series of values. The quantum receiver produces a revised series of values based on its choice to keep the value of its initial series of values or to change to a value deduced from the eliminative series of values.

The said quantum device derives a transmitting series of modulations based on its master series of values and an appropriate encoding translating a value into a modulation.

Likewise, the receiving quantum device derives a receiving series of modulations based on its revised series of values and the same appropriate encoding used by the said quantum device.

Alternatively, the said quantum device may disclose a wildcard value in its eliminative series of values to cancel any strategy during the Monty Hall Problem. This option is left to avoid any side attacks during which a hacker could steal the master series of values stored in memory in the said quantum device and deduce the corresponding encodings during the preprocessing step.

Post processing steps are now impacted by this method keeping in mind that the probability of an eavesdropper gaining knowledge on a specific bit of the secret is no longer following a “flat” distribution, but rather, depends on the choices made by the receiving quantum device when it built its revised series of values.

Natural errors impact bits indifferently. Reconciliation cannot disclose details on the probabilities of errors when blocks are created and parity are being computed.

Privacy amplification considers different subsets of bits depending on the relative probability of basis match when determining the potential amount of information an eavesdropper obtained on these bits. The hashing functions used there should be adapted to the different subsets and the overall secret should be decomposed in subsets first.

### Where the Receiver Keeps its Initial Choice as Means of Detecting An Eavesdropper

To defeat an eavesdropper applying the same strategy as the quantum receiver, the receiver may finally decide that for a specific bit, it will keep its initial choice with a probability p chosen at its convenience. Then, the revised series of values may contain values from the initial series of values. The receiver discloses its decision to keep or change its choice only after measurement took place that is during the sifting technique occurring in the post processing phase, so that the potential attacker cannot predict for a given bit of the secret when the receiver maintains the value of its initial series of values into the revised series of values.

When the receiver kept its choice and its initial choice matched the choice of the transmitter in its master series of values then an eavesdropper is detected when the eavesdropper used a value in the eliminative series of values it captured from the public channel and that is not in the initial series of values. In this case the eavesdropper introduces an error which happens

$$\frac{1}{2 N} . p$$

of

the time.

If the eavesdropper uses only the initial series of values from the receiving quantum device, then it introduces errors in the case where the receiver used a value in the eliminative series into its revised series of values matched the corresponding value in the master series of values of the said quantum device, which happens

$$\frac{N - 1}{2 N} \cdot ( 1 - p )$$

of the time.

### Where the Transmitter Introduces Wildcard Values

In parallel the transmitter may decide that for a selection of the bits of secret to be exchanged, it will not disclose any information on its master series of values with a probability of pw. It will disclose the basis it chooses for this specific case only after measurement has been performed, that is during the sifting technique of the post processing step. The main advantage of this option is to prevent an attacker to foresee the use of the modulations by the transmitter. In this case, the quantum receiver has no valid strategy to apply, so it proceeds to “flip a coin”, that is to fallback in existing BB84 algorithms for instance. Eavesdropper is being detected the conventional way with a probability of

$$\frac{{p}_{w}}{2 ( N - M )} .$$

The method tries to implement the Monty Hall Problem. Compared to existing QKD algorithm, it requires a preprocessing step where the quantum receiver and the said quantum device negotiate N the size of the predefined selection space, N−M the size of the reduced selection space, L the required length of the secret to be exchanged and pw.

### Determination of the Number of Quantum Objects to Send

The total required length L is determined as being the length of the secret to achieve (typically of 256 bits) over 1 minus the sum of:

The probability that a basis mismatch occurred when a wildcard value is generated for that specific bit

$$( \frac{pw \cdot ( N - M - 1 )}{2 ( N - M )} )$$

The probability that a basis mismatch occurred when the receiver kept its choice

$$( \frac{p ( N - 1 )}{2 N ( N - M )} )$$

The probability that a basis mismatch occurred when the receiver changed its choice

$$( \frac{( 1 - p )}{2 N} )$$

A safety margin is also added to take into account channel noise and receiver errors plus a detection threshold and the loss of data related to ancillary operations such as sifting, reconciliation and privacy amplification. Depending on the parameters exchanged during this handshake, the quantum receiver may require to increase L, or may abandon on the future exchange to be performed.

### Establishment of the Eliminative Series of Values

Then for each of the bits that will constitute the secret, the quantum receiver generates a random sequence of length L of values ranging from 1 to N. The quantum receiver then discloses this sequence as the initial series of values to the said quantum device via the public channel.

The said quantum device generates a random sequence of length L of values ranging from 1 to N. It keeps this sequence secret as its master series of values. It generates a new sequence of dimension 2 of L×[N−M] values, where each value in the sequence of L elements is a space of size N−M of selected values with the condition that the corresponding value of the sequence sent by the receiver is present and that the corresponding value of the sequence generated by the transmitter is present. The N−M values can usually be stored as a “bit vector” wherein the index of the bit being set carries the values itself. The bit vector is an efficient way to “compress” the values in its sequence. Alternatively, if N−M equals 2, leaving the quantum receiver to keep the value from the initial series of values or change with only one option, then the said option can be sent in place of the bit vector.

This new sequence is called the eliminative series of values. The said quantum device can also replace the space of size N−M by 0 or a wildcard value to declare that no strategy can be applied specifically for the corresponding bit.

Upon receipt of the eliminative series of values, the quantum receiver now constitutes a revised series of values considering that changing the value from its initial series of values will lead to an increase in choosing the encoding basis of the said quantum device. But in no case it is guaranteed, as the probability that the said quantum device initially selected the same basis as the quantum receiver equals 1/N, in which changing from the initial series of values will lead to a basis mismatch, and the corresponding bits of secret will be discarded during the sifting phase of the post processing step.

### Mapping Between N and the Number of Bases

Now that the quantum receiver obtained the eliminative series of values, it has an increased chance of using the right bases to perform measurement on the secret being transmitted. However it relies on an efficient mapping to convert the values from the predefined selection space, or the reduced selection space into the corresponding basis.

Most of the time, N and the number of available bases differ, as the QKD systems may rely on hardware that offers practically only two different bases (rectilinear and diagonal) and as N is big enough to increase chances of basis match. It is however recommended that N−M is at most the number of available basis so that the reduced space lead to a one to one correspondence with the bases.

A good bijective function is required to provide no chance for an eavesdropper to predict what the said quantum device and the quantum receiver will use as basis based on the disclosed initial series of values and eliminative series of values. Table III presents the specific case where N=3, M=1, and illustrates a bijective function. The corresponding encoding and the ultimate choice of modulation is provided as an example. The reduced selection space has two values and the basis is selected by comparing the values in the eliminative series of values.

The said quantum device chooses the basis according to the bijective function. In the example provided this is a “min max” function, if the value it selected in its master series of values is the least one in the revised series of two values, then it will choose the rectilinear basis, and if it is the maximum it will choose the diagonal basis.

The quantum receiver on its side selects its basis using the same bijective function depending on the choices left in the revised series of values, the smallest value leading to the rectilinear basis and the greatest one to the diagonal basis.

The bijective function ensures that when the said quantum device and the quantum receiver exchange the initial series of values and the eliminative series of values, the resulting basis cannot be determined, that is the probability that a basis is selected over the other ones is equally distributed.

Finally, in case of a wildcard value selected for a specific bit, strategy is made pointless and the bijective function is bypassed, that is, both the said quantum device and the quantum receiver decide which modulation to choose on the fly, and the choice of a specific basis over the other ones is done with equal probabilities so that an eavesdropper gains no advantage on the wildcard value.

### Method to Detect an Eavesdropper

Finally, once the eliminative series of values is being received, the said quantum device can start sending the photons over the quantum channel and modulate the photons by polarizing them considering the master series of values translated into a basis by means of the said bijective function, or a random basis in case of a wildcard value in the eliminative series of values.

The quantum receiver selects a basis to perform the measurement of the state of polarization of incoming photons based on the revised series of values by considering if it keeps the values in its initial series of values or if it changes it using the eliminative series of values, and then uses the bijective function to translate it into a basis. If the value was wildcard in the eliminative series of values, then it randomly chooses a basis to perform its measurement.

An encoding for the secret to be modulated depending on the basis is described in BB84 et al. Table IV shows an illustrative example.

Thus, if the result of the bijective function for the value in the master series of values of the said quantum device was that a rectilinear basis is applied on the photon and the corresponding bit of the secret to encode was a zero, the photon would now have a horizontal polarization. The quantum receiver randomly selects the basis thanks to its bijective function, if it selects the rectilinear basis, then it would read 0 most of the time, whereas it would randomly read either 0 or 1 if it applies the diagonal basis.

The detection of an eavesdropper is made when the quantum receiver and the said quantum device initially selected the same value and that the quantum receiver decided to keep the value from its initial series of values. In this case it is translated into the quantum receiver applying the same basis as the said quantum device. If the eavesdropper believed the quantum receiver would use a value in its revised series of values that is not in the initial series of values for a given bit—which it will likely do in order to maximize its chances of gaining knowledge on the secret while being unnoticed—then it has 50% chance to introduce an error for this specific case.

We call the corresponding bits the strong bits, as they act as watchdogs for the system to detect an eavesdropper. Moreover, they also can guarantee the presence of an eavesdropper that is aware of the strategy, and that is applying this strategy on purpose. The rate p then determine the speed to discover the eavesdropper. A small value means a longer key material would be used to discover the eavesdropper. On the contrary, a high value of p means that the quantum receiver decides to sacrifice its bits because most of the time it will not select the right basis, but by doing so, it increases the chance to detect the eavesdropper.

The wildcard values bar everyone from applying any strategy, eavesdropper included. This is a fallback mode where conditions of BB84 algorithm apply. In the case of two available basis, the quantum receiver has 50% chance of selecting the same basis as the said quantum device, and the eavesdropper has 50% chance of being wrong. In the case of the eavesdropper being wrong, it has 50% chance of introducing errors in the receiver side. 25% of the corresponding bits are in error if an eavesdropper tried to gain knowledge on them.

We call the corresponding bits the neutral bits, as they still provide means of detecting an eavesdropper but they are slightly less efficient at providing this detection. The remaining bits are called the weak bits. The quantum receiver has an increased chance of selecting the basis used by the said quantum device, but there are practically no means of detecting the presence of an eavesdropper.

Both the quantum receiver and the said quantum device present these three lists to the error correcting code. Ancillary operations such as sifting, key reconciliation and privacy amplification occur here. The quantum receiver sends back to the said quantum device, after the photons have been measured, the revised series of values. If there is ambiguity, for example where N−M>2 or where a wildcard value correspond to the bit, the said quantum device and the quantum receiver exchange the basis they used.

Sifting is still used to determine when the bases do not match and corresponding bits of the message may be discarded. Reconciliation determines blocks of the secret on which to apply bit parity based on the relative distribution of strong, neutral and weak bits. As disclosing the parity provides information on the secret, strong bits should not be weakened. Privacy amplification is made by decomposing the three series of strong, neutral and weak bits, and perform privacy amplification separately on these three series using hashing functions of prior art separately as the level of knowledge of an eavesdropper varies from strong, neutral and weak bits.

The error correcting code then returns the number of errors for each of the series of bits, strong, neutral and weak namely. An error rate is computed by dividing the number of errors to the size of each of the series.

A threshold is determined based on the loss of the channel and the error induced by the receiver due to noise. It is considered that if the error rate is statistically greater than this threshold, then it can be assumed that an eavesdropper is present tapping or tampering the quantum channel. A lookup table is finally applied to determine the set of actions to take. If:

The error rate is below the threshold for all the strong, neutral and weak series, then the systems have good reason to consider that no eavesdropper is present and they can negotiate different N, p and pw in future transmissions to increase the speed of delivering messages

The error rate is above the threshold for all the strong, neutral and weak series, then the system may consider that either the quantum channel is impaired or an eavesdropper tries to gain knowledge on the secret and the eavesdropper is not applying any strategy

On the contrary the error rate in the strong series exceeds the ones of the neutral or the weak, then an eavesdropper is listening on the public channel and use information disclosed on that channel to apply a strategy

Finally the error rate on the weak series may exceed the ones of the neutral or the strong series, which means that an eavesdropper tries a strategy as well.

The information can be passed to the privacy amplification step by instructing the relative error rates per series to help that block determine how many bits of each of the series to eliminate to virtually give an eavesdropper no knowledge on the resulting secret. If the quantum receiver and the said quantum device determine on the contrary that too much knowledge is compromised, especially in the weak series, they may decide to interrupt the sharing of the secret.

It will be appreciated that both the receiving quantum device and the “said quantum device”, that is the quantum device with which the receiver is exchanging the various series to determine if they have used the same modulation bases, may perform the same error detection steps as claimed.

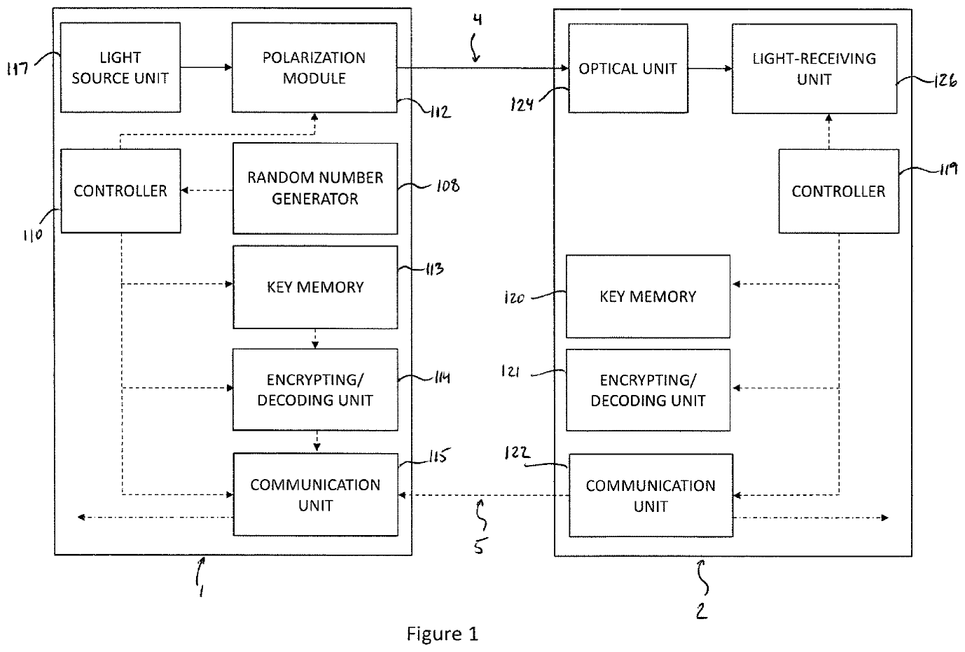

FIG. 1 is a depiction of related art quantum encryption communication system. The purpose of this figure is to provide material and sufficient explanation for a reasonable person who is not an expert in this field to obtain tractable information.

A quantum communication pair of devices called a transmitter 1 and a receiver 2 operate on two distinct channels 4 and 5. The quantum channel 4 is exchanging the quantum key in case of a quantum encryption communication, or a quantum message in the more general case of quantum communications. The quantum channel 4 of related art is generally an optical link between the two devices and can be a fiber optic, or a free space optic channel. Note that light is a popular medium for quantum communications, but other entities that can act as both a wave and a particle or be in a superposition of states can transport quantum information.

The classical channel 5 is usually the Internet, or by opposition to quantum channels any existing communication technology able to transport a message electronically between two systems, for example LAN or WDM. The classical channel is assumed authenticated. A successful man-in-the-middle attack consists of an intermediate system acting as either the transmitter from the receiver side, or the receiver from the transmitter side. The quantum transmitter 1 and the quantum receiver 2 are authenticated for the quantum communication system to safely exchange sensitive data.

In FIG. 1, a random number generator 108 is used to randomly select a set of basis to encode photons on different polarization basis as long as the two bases are non-orthogonal. In the quantum encryption communication area, a second set of random values can be generated by the random number generator to encode bit on orthogonal polarizations, vertical (V) or horizontal (H) in the linear basis, or diagonal (L), or anti-diagonal (R) in the diagonal basis. Table V shows a potential encoding of the polarization of light in degrees depending on the selected basis (series of modulation) and the bit value of the message to be sent. Note that this is just an example and different encodings can be used:

The controller 110 is generally a CPU or a MCU unit. It selects a number from the random number generator 108 and controls the polarization module 112 accordingly to the value obtained so that the emitted photons are modulated with a polarization that matches the value obtained from the generator 108. The controller 110 stores the key material in the key memory 113. It is believed the encrypting and decoding unit 114 is used to implement the avalanche protocol, the hash block providing a summary of the key material, and the communication unit 115 is either a CPU, a MCU, or can be a software and a controller using a legacy network to communicate results, and the basis that was selected.

The light source unit 117 is usually a single photon light source. Its role is to send 0 or 1 photon at a time so that an eavesdropper cannot gain more than one copy of a photon at the same time. Otherwise measuring a copy of the photon could be unnoticed. It is generally a faint laser, a conventional laser that is attenuated so that the number of photons per pulse follows a Poisson distribution.

Similarly, a quantum receiver 2 possesses the same controller blocks as the transmitter 1 to retrieve information, that is the receiver also has a controller 119, key memory 120, encrypting/decoding unit 121 and a communication unit 122. Only, an optical unit 124 collects the photons, may be synchronized to perform the measurement of the photons, and a receiving unit 126 to retrieve the polarization of the transmitted photon. Using the same encoding technique as in the previous table, the controller 119 is able to retrieve what it believes was the initial bit value transmitted. Using the communication module 122 it can disclose the bases it chose, and provide as well a summary of the key material obtained.

Key reconciliation and privacy amplification are classical steps performed to correct potential errors on the key material stored in memory and to measure the eventuality of the presence of an eavesdropper. By trimming the key material, the quantum receiver and the quantum transmitter end up with a shared secret of a smaller size designed so that the eavesdropper gained practically no knowledge on this said secret.

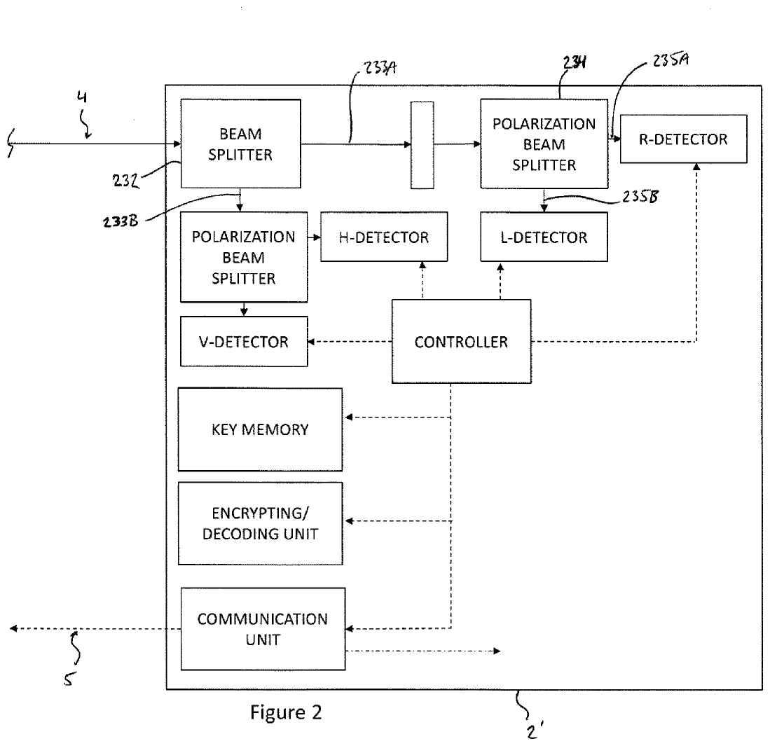

FIG. 2 shows an example of a passive receiver 2′ used to perform the said measurement. In general a passive beam splitter 232 forwards a photon with probability p in one arm 233A, and probability 1−p in a second arm 233B, but most of the cases p equals 50%. In one arm, a polarization beam splitter 234 directs the photon to one of its two arms 235A, 235B depending on its polarization to select measurement in the linear basis. In a second arm, a liquid crystal, a ¼wave plate for example, is used to select measurement in the diagonal basis. In the same way, a polarization beam splitter is used two split the photon depending on its polarization. Photon with a polarization that does not match the receiving basis has 50% chance of being detected and sent to one arm of the polarization beam splitter and 50% chance of being sent to the second arm. Photon with a polarization that matches the receiving basis, ideally, has 100% chance of being sent to the corresponding arm of the polarization beam splitter. In practice, errors occur, such as detection errors, noise, or the presence of an eavesdropper.

Following the example of BB84 with beam splitters showing a ratio of 50%/50%, Table VI shows the respective probability of measuring a photon in function of its polarization. The reader should match the corresponding rows and columns to obtain the probability of a successful transmission between the transmitter and the receiver. A mismatch of either linear or diagonal basis that is disclosed on the classical communication channel usually leads to the corresponding value to be flagged as invalid and discarded during the sifting phase of the post-processing step.

For example, if the transmitter sent a photon with polarization H, and the beam splitter of receiver sent the photon to its linear basis set of detectors, then ideally, the polarization H is measured. If the beam splitter sent to the diagonal basis set of detectors, as the basis is non-orthogonal, chances of getting a R or a L polarization is equally split resulting in 50% of probability of getting the initial 0 (see first table) and 50% of being wrong and measuring a 1.

An eavesdropper that tries to measure a photon and resend to a receiver the value it reads has the same risk of performing the wrong measurement. Quantum encryption communication is based on the premise that the bases used by the transmitter are known only after the measurements have been performed. In this case:

If the receiver basis did not match the transmitter basis, then the receiver has 50% chance of being wrong regardless of if an eavesdropper was successful, and the bit is discarded

If the receiver basis did match the transmitter basis and the eavesdropper choice of basis did match the transmitter basis, then the eavesdropper is unnoticed

If the receiver basis did match the transmitter basis and the eavesdropper choice of basis did not match the transmitter basis, then the eavesdropper has 50% of chance of measuring the wrong value, and the receiver will measure the wrong value. The chance to detect an eavesdropper in this case is of 25%.

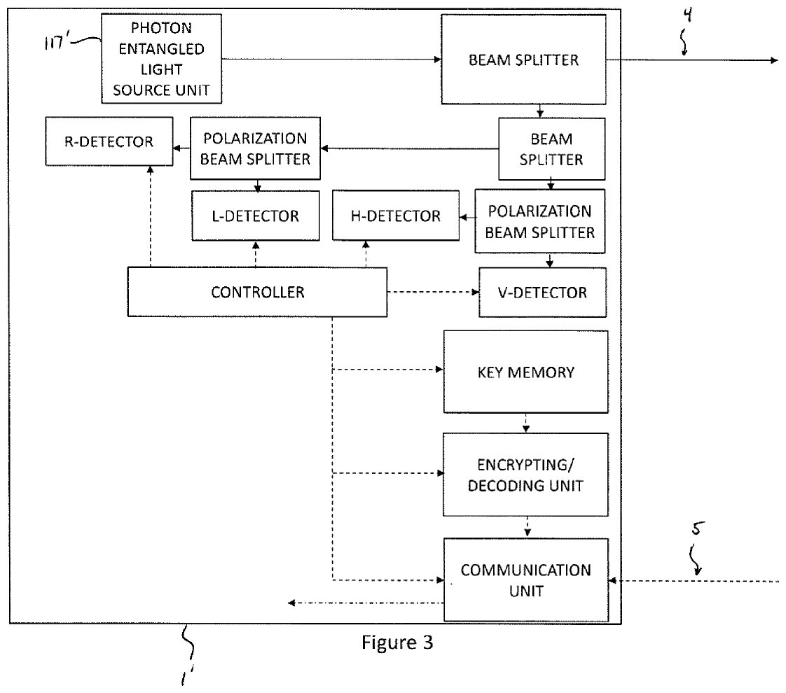

FIG. 3 illustrates the second example where the transmitter 1′ is entangling photons. The receiver is usually the same as in FIG. 2. In FIG. 3 a light source unit 117′ is preparing multiple photons, at most 2 so that an attacker does not obtain an extra copy of the message to be sent, with the exception that the photons are entangled. They form a system in which measuring a copy of a entangled photon immediately impacts the second photon, so that if the receiver chooses the same basis as the transmitter, both copies share the same polarization.

However, FIGS. 1, 2 and 3 of the related art describe passive measurement, and potential implementations of related art quantum encryption communication algorithms such as BB84 with probabilities of choosing either basis with 50% of probability, thus being able to detect the presence of an eavesdropper in 25% of the cases. In an existing patent, active optics is being used to the transmitter side to actively choose the transmission polarization based on a set of random numbers that were generated. It is in contrast with FIG. 3 where the transmitter side performs a passive measurement of one copy of the entangled photons, the other copy being sent to the receiver.

In fact, active and passive measurement or polarizations of the light could be applied to entangled or prepare-and-measure schemes of FIGS. 1, 2 and 3. In passive measurements, probabilities of selecting a basis depend on the beam splitter ratio and no measurement strategy is performed. This term is also coined as “tossing a coin” to perform basis selection. In active measurement or polarization of light, a random number generator is used, and a strategy can be applied. It is not however, to the knowledge of the author that such strategies are applied, or if strategies are applied, they may introduce determinacy which gives chances to an eavesdropper to gain knowledge on the secret to be shared, unnoticed, simply by applying the same strategy.

This solution relies on active optics on both entangled or prepare and measure schemes, and offers a selection strategy. Here the receiver discloses the basis it may select in the future, and the transmitter selects basis it will not select, or decline to disclose such an information. Based on the output of the transmitter, the receiver may choose to keep its initial choice, or may change its choice.

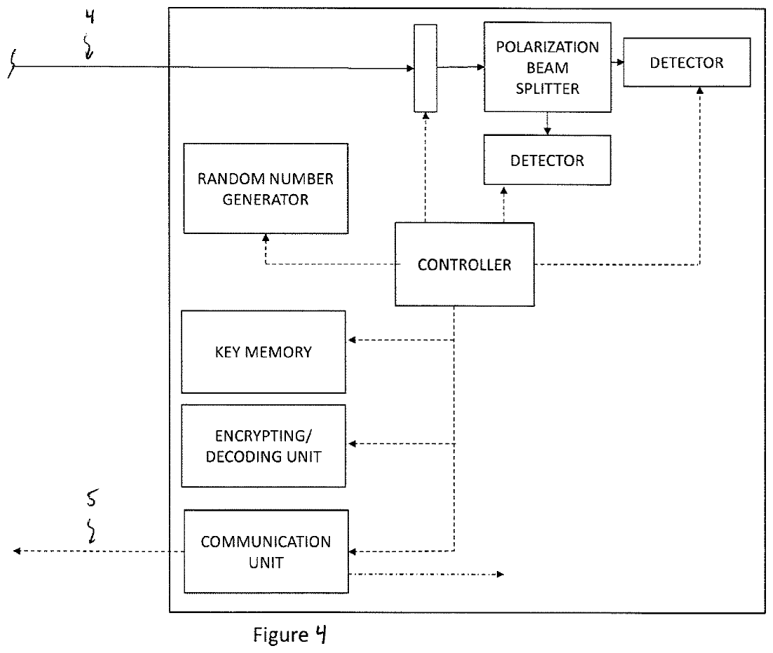

FIG. 4 presents a related art diagram of a prepare and measure set of transmitter and receiver systems performing quantum communications, or specifically, quantum encryption communications. The receiver system has also a random number generator, and communicates the result through the communication unit, and store the result from the transmitter in its key memory block. The transmitter (not shown) also keeps an initial record to control chances of success of receiver. In FIG. 4, a polarization retarder, made of, for example, liquid crystal may or may not shift polarization of incoming photon, based on the decision of the controller using the random number generator and the output of the transmitter obtained from the communication unit.

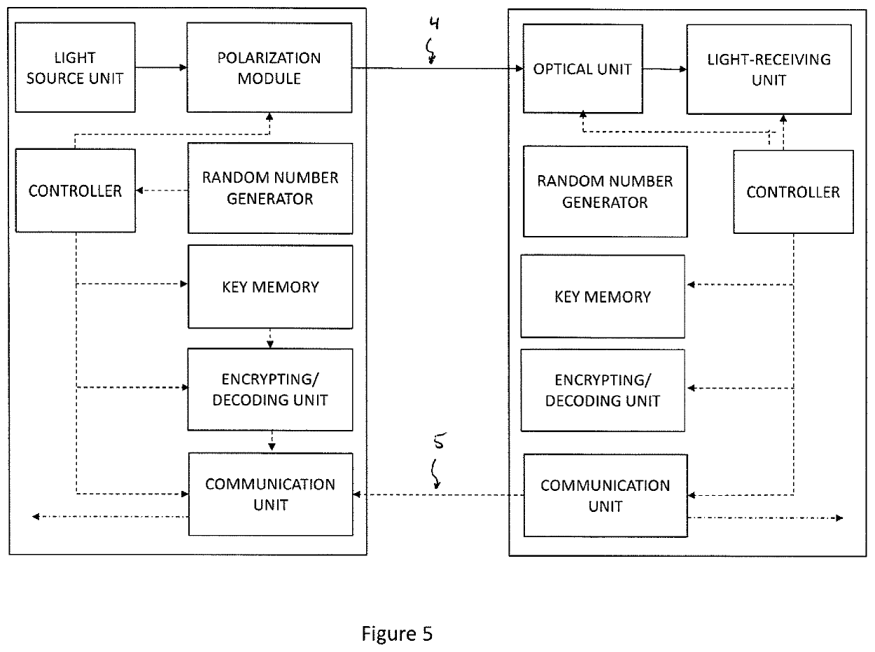

FIG. 5 shows a related art system applying this active concept.

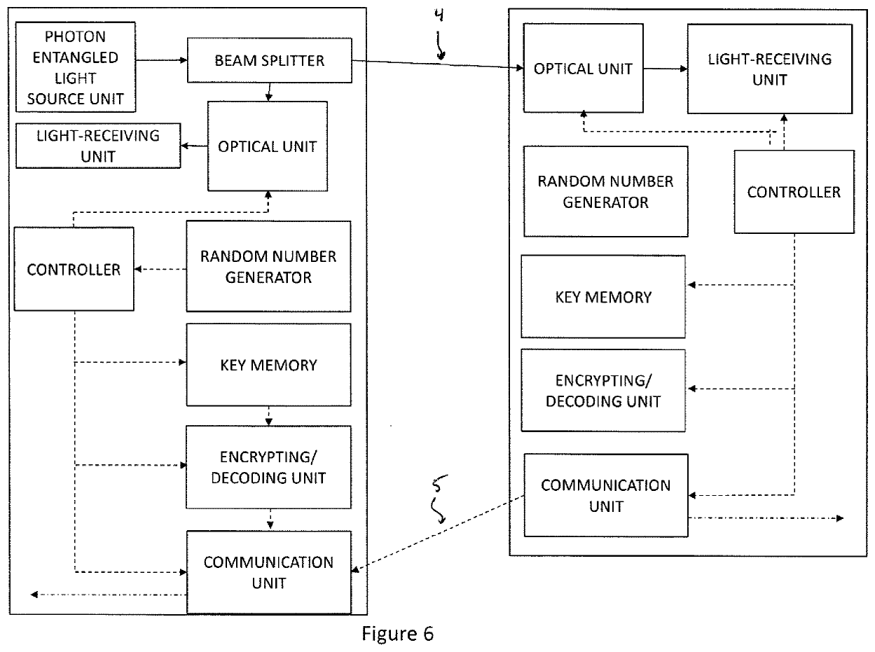

FIG. 6 shows a related art system implementing entangled protocol scheme in which active measurement on one of the two entangled photons is being performed by the transmitter, and the other copy is sent to the receiver.

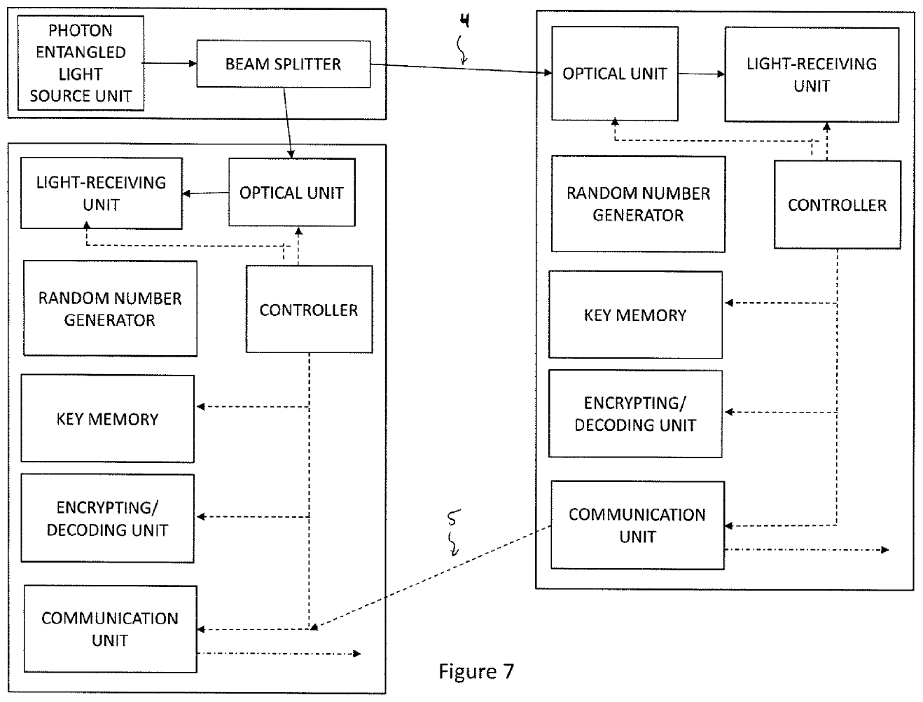

FIG. 7 shows a potential related art system where an external source of entangled photon is being used transmitting a copy of entangled photon to 2 or more receivers, and in which receivers independently apply measurement, using the classical communication between them to disclose the bases they selected. The source of entangled photons can also use the classical channel to monitor the transmissions, and may also be a unit that performs a measurement of a copy of the photons on its own if more than 2 entangled photons is being generated.

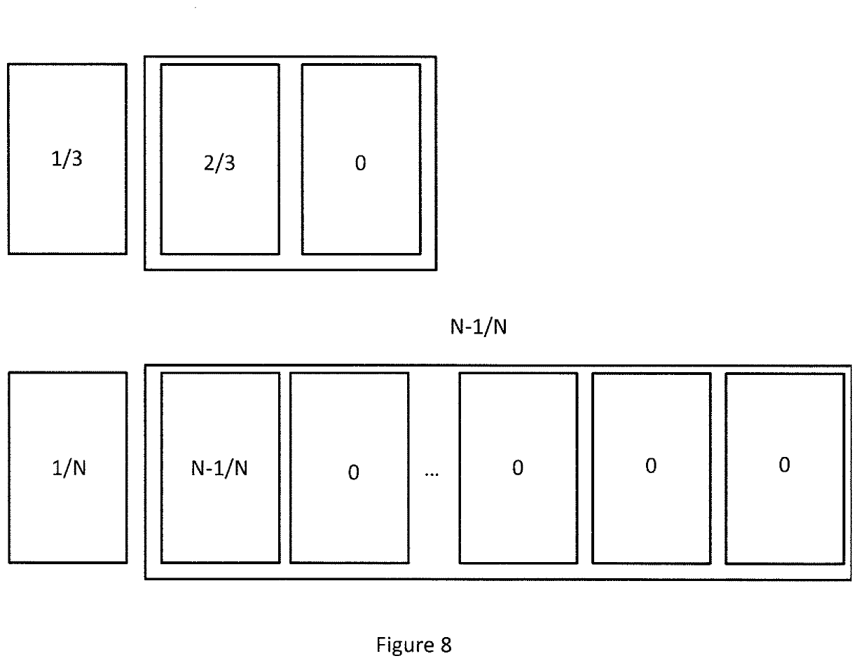

FIG. 8 shows the distribution of probabilities during the preprocessing step (Monty Hall problem) for two single iterations on the exchanged series of value for the receiving quantum device to anticipate correctly the corresponding value of the master series of the said quantum device. It corresponds to two different preselection spaces (top, preselection space of size 3, bottom, preselection space of size N). The receiving quantum device selected for that specific iteration a value in its initial series of values as shown by the box on the left. The said quantum device replied with a series of eliminative values. For that specific iteration, the values correspond to the boxes flagged with a probability of ‘0’. The two boxes showing non zero values correspond to the values in the eliminative series. Chances to anticipate the right value in the master series are not equal.

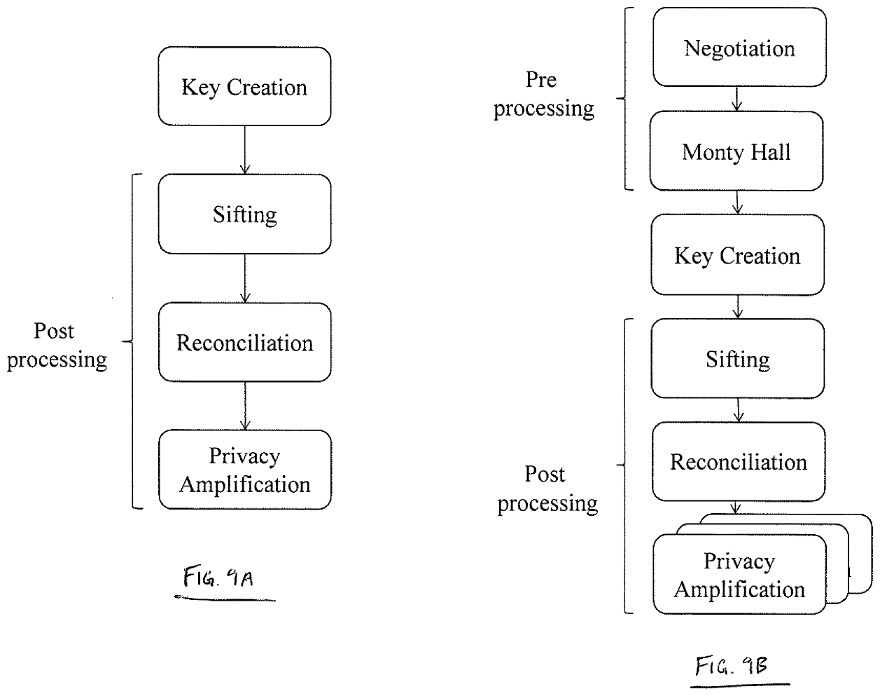

FIG. 9(a) shows the prior art flowchart of a QKD system. The exchange of quantum object is made during the key creation phase. A post processing phase then occurs letting the quantum devices exchange information to mitigate the effects of errors introduced naturally by hardware or by eavesdroppers. Sifting first checks the quantum objects that were measured with the right basis (modulation), reconciliation checks which bits are in error and privacy amplification trims the key material to reduce potential knowledge on the secret of an eavesdropper.

FIG. 9(b) shows the pre-processing step introduced by this method. Quantum devices first negotiate the parameters of the Monty Hall problem, and then execute the Monty Hall problem for each quantum object being transmitted during the key creation. Key creation occurs as usual. During the sifting process, the quantum devices may exchange the revised series of values and the master series of values instead of the series of modulations. Sifting is performed as in prior art. Reconciliation is made as in prior art considering that the blocks should not weaken the strong series more than it would do in prior art. For instance, providing parity on strong bits only may weaken this series. Providing parity on a good mix of strong, neutral and weak bits helps maintain strength of series. The bit that is discarded at the end of each block may be a weak bit. Privacy amplification is being performed on each of the three series considering the different amount of information obtained by an eavesdropper, it is considered that the amount of information is low on strong bits, slightly more important on neutral bits, and weak bits are the least secure.

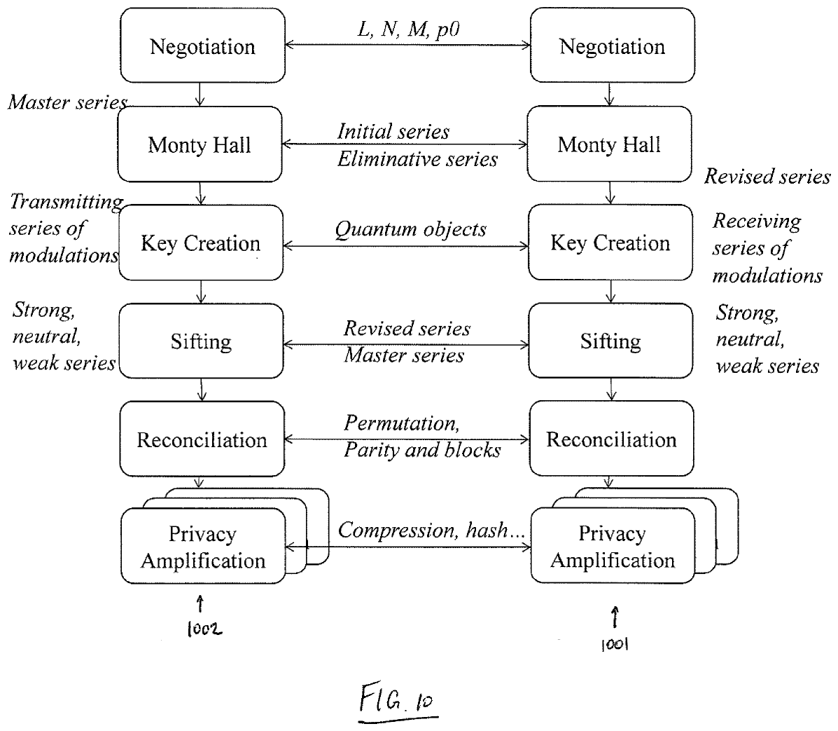

FIG. 10 shows the flow chart between a quantum receiver 1001 and a “said quantum device” 1002 which may be a transmitter or another receiver receiving quantum objects from a common transmitter as the receiver 1001. The arrows between the two stacks of steps reflect the exchange of information on both the public channel and the quantum channel. The eavesdropper can intercept messages on these arrows. During negotiation, parameters for the Monty Hall Problem are being negotiated, L is the number of quantum objects being transmitted during key creation, N is the predefined selection space length, M defines the dimension of the eliminative series of values where the eliminative series of values is an array of dimension L×M, p0 is an optional value mentioning the rate of wildcard values being produced by the said quantum device. Then the Monty Hall problem is executed over L quantum objects. Master series and revised series are kept private. Initial series of values and the corresponding eliminative series help determine the transmitting and the receiving series of modulations based on a bijective function discussed in this method. Quantum objects are being exchanged as defined in prior art using the series of modulation. During sifting, only revised and master series may be exchanged, not necessarily the series of modulations in order to slightly increase security, unless a wildcard value was present in the eliminative series. In this case, the modulation used is exchanged between the two devices to eliminate quantum objects measured with the wrong basis. Reconciliation is performed as in prior art considering the strong bits should be mixed with other bits in blocks in order not to weaken them during bit parity checks. Strong, neutral and weak series are used to defined three subsets to perform privacy amplification on as in prior art.

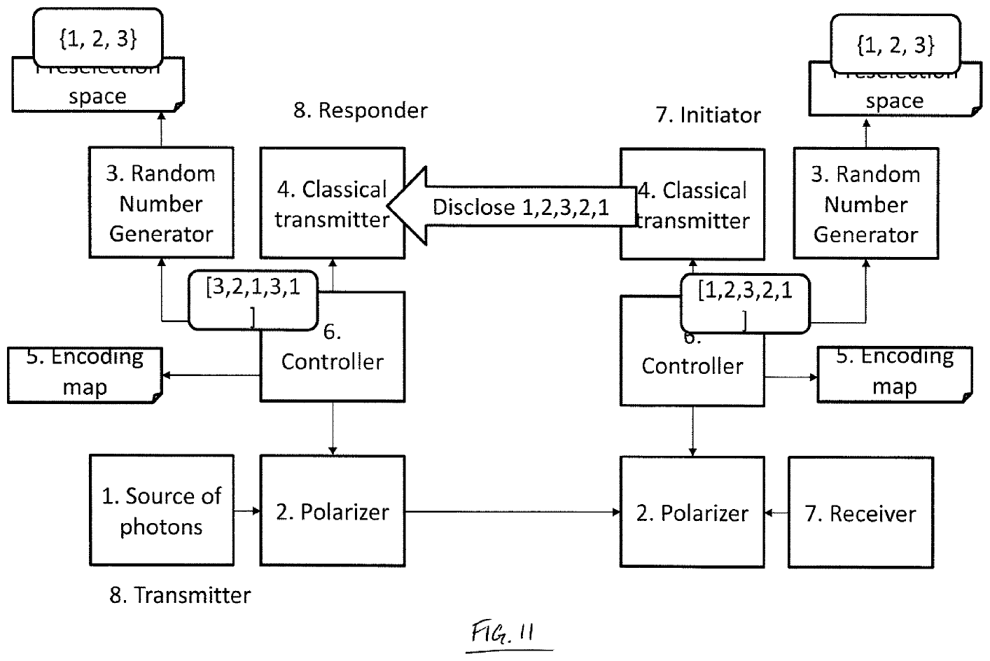

FIG. 11 shows an example first step of Monty Hall process after negotiation defined predefined selection space of 3 and eliminative series of values of 2 and p0 equals 0 (no wildcard value). In the illustrated example, the said quantum device on the left determined [3,2,1,3,1] as its master series and the quantum receiver selected [1,2,3,2,1] as its initial series of values.

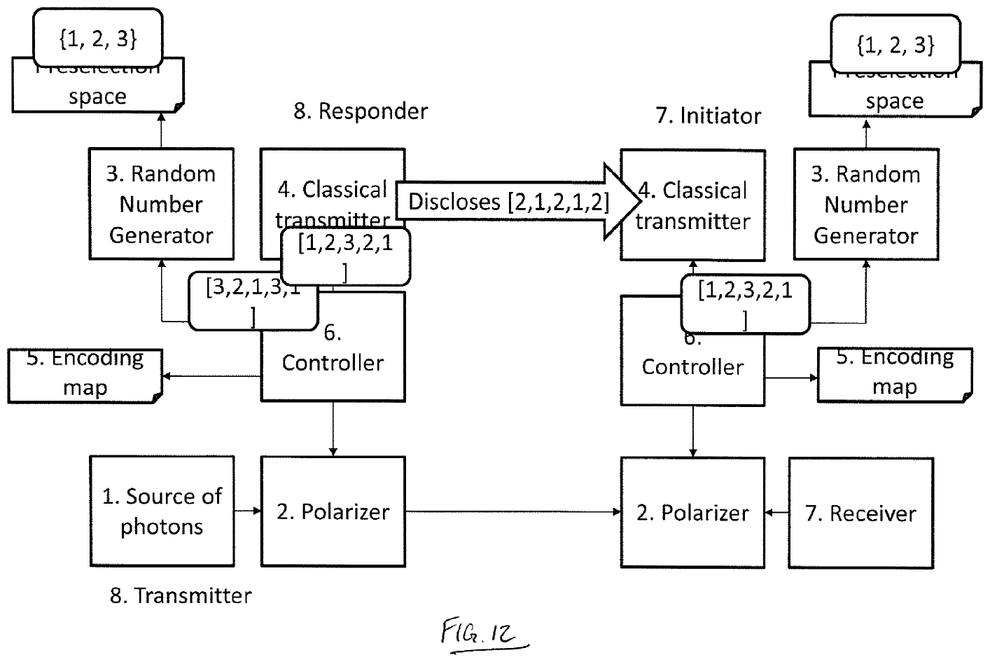

In FIG. 12, the said quantum device uses its master series of values to produce an eliminative series of values based on the initial series of values it receives from the quantum receiver. Each of the value in the eliminative series of values is a value that is not in the master or the initial series of values. For example, the first value in the master series of values being 3 and the first value in the initial series of values being 1, the first value in the eliminative series of values will be 2. In this example, the second value in the master and the initial series equal 2, in this case, the said quantum transmitter selects randomly either 1 or 3 as second value for its eliminative series of values.

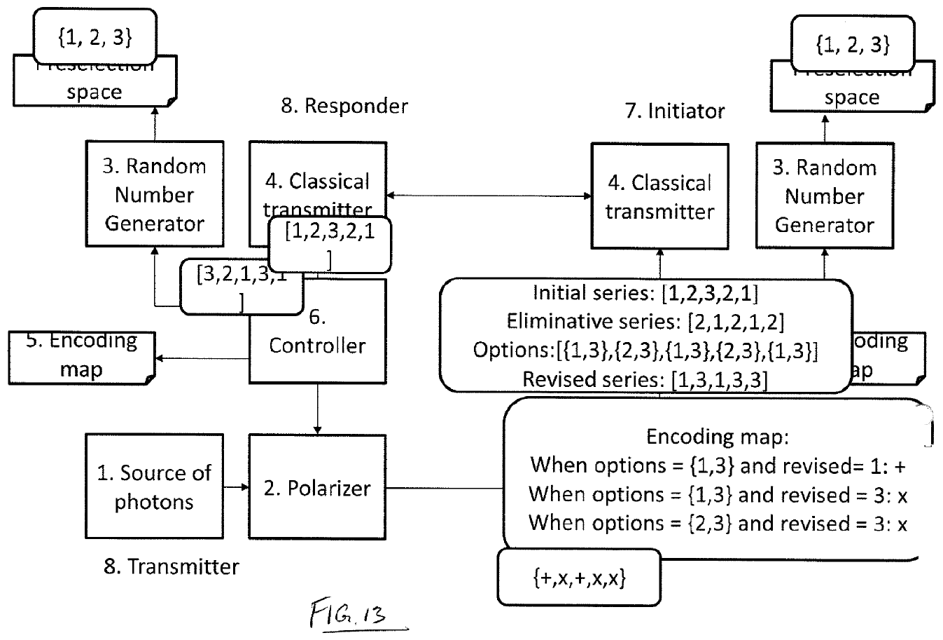

FIG. 13 shows the quantum receiver creating a revised series of values based on the eliminative series it obtained from the said quantum receiver. Each of the values in the revised series of values correspond to either a value in the initial series of values, if the quantum receiver wanted to keep its initial choice, or an option left by considering the eliminative series of values. The quantum receiver then produced a revised series of [1,3,1,3,3]. An encoding map translates the revised series of values into a receiving series of modulation, where ‘+’ stands for the rectilinear basis and ‘x’ stands for the diagonal basis.

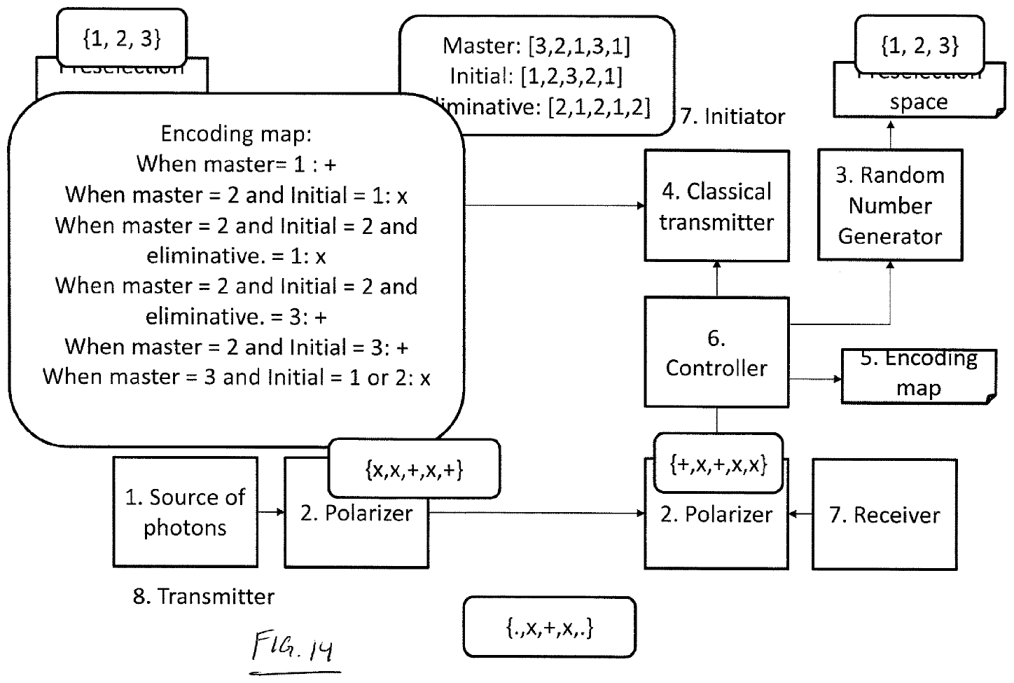

FIG. 14 shows the said quantum device producing a transmitting series of modulation based on the master and initial series of values and using the same encoding map translating the master series of values into the said series of modulations. Encoding and measurement are being held using prior art hardware. Sifting is made by comparing the revised series of values and the master series of values letting the quantum devices determine the respective bases they chose and eliminating the quantum objects for which the bases did not match. In this example, the first and the last values of these series of modulations did not match, and the sifting step would discard corresponding quantum objects.

The scope of the claims should not be limited by the preferred embodiments set forth in the examples but should be given the broadest interpretation consistent with the specification as a whole.

### TABLES

TABLE I
a brute force analysis where N = 3 and M = 1.

| | Prize | | | | |
|---|---|---|---|---|---|
| Candidate | hidden | | | | |
| initially | behind | Presenter | | Strategy | |
| chose | door | disclosed | Probability | Keep | Change |
| 1 | 1 | 2 | 1/18 | Win | Lose |
| 1 | 1 | 3 | 1/18 | Win | Lose |
| 1 | 2 | 3 | 1/9 | Lose | Win |
| 1 | 3 | 2 | 1/9 | Lose | Win |
| 2 | 1 | 3 | 1/9 | Lose | Win |
| 2 | 2 | 1 | 1/18 | Win | Lose |
| 2 | 2 | 3 | 1/18 | Win | Lose |
| 2 | 3 | 1 | 1/9 | Lose | Win |
| 3 | 1 | 2 | 1/9 | Lose | Win |
| 3 | 2 | 1 | 1/9 | Lose | Win |
| 3 | 3 | 1 | 1/18 | Win | Lose |
| 3 | 3 | 2 | 1/18 | Win | Lose |
| — | — | — | 1 | ⅓ | ⅔ |

TABLE II
the probabilities of finding the prize by changing option.

| | M = 1 | M = 2 | M = 3 | M = 4 | M = 5 | M = 6 |
|---|---|---|---|---|---|---|
| N = 3 | 2/3 | — | — | — | — | — |
| N = 4 | 3/4 | 3/8 | — | — | — | — |
| N = 5 | 4/5 | 2/5 | 4/15 | — | — | — |
| N = 6 | 5/6 | 5/12 | 5/18 | 5/24 | — | — |
| N = 7 | 6/7 | 3/7 | 2/7 | 3/14 | 6/35 | — |
| N = 8 | 7/8 | 7/16 | 7/24 | 7/32 | 7/40 | 7/48 |

TABLE III
a bijective function where N = 3, M = 1.

| | | | | Said | | |
|---|---|---|---|---|---|---|
| | | | | quantum | | |
| | | | | device’s | Quantum receiver action | |
| Value in | Value in | Eliminative | | choice of | Choice of | |
| the initial | the master | series of | Case | basis | basis | |
| series | series | values | Probability | (modulation) | (modulation) | probability |
| 1 | 1 | 2 | 1/18 | + | + | 1/18.p |
| 1 | 1 | 2 | | + | × | 1/18.(1-p) |
| 1 | 1 | 3 | 1/18 | + | + | 1/18.p |
| 1 | 1 | 3 | | + | × | 1/18.(1-p) |
| 1 | 2 | 2 | 1/9 | × | + | 1/9.p |
| 1 | 2 | 2 | | × | × | 1/9.(1-p) |
| 1 | 3 | 3 | 1/9 | × | + | 1/9.p |
| 1 | 3 | 3 | | × | × | 1/9.(1-p) |
| 2 | 1 | 1 | 1/9 | + | × | 1/18.p |
| 2 | 1 | 1 | | + | + | 1/18.(1-p) |
| 2 | 2 | 1 | 1/18 | × | × | 1/18.p |
| 2 | 2 | 1 | | × | + | 1/18.(1-p) |
| 2 | 2 | 3 | 1/18 | + | + | 1/9.p |
| 2 | 2 | 3 | | + | × | 1/9.(1-p) |
| 2 | 3 | 3 | 1/9 | × | + | 1/9.p |
| 2 | 3 | 3 | | × | × | 1/9.(1-p) |
| 3 | 1 | 1 | 1/9 | + | × | 1/18.p |
| 3 | 1 | 1 | | + | + | 1/18.(1-p) |
| 3 | 2 | 2 | 1/9 | + | × | 1/18.p |
| 3 | 2 | 2 | | + | + | 1/18.(1-p) |
| 3 | 3 | 1 | 1/18 | × | × | 1/9.p |
| 3 | 3 | 1 | | × | + | 1/9.(1-p) |
| 3 | 3 | 2 | 1/18 | × | × | 1/9.p |
| 3 | 3 | 2 | | × | + | 1/9.(1-p) |

TABLE IV
An encoding for the secret to be modulated depending
on the basis is described in BB84 et al.

| | Rectilinear Basis | Diagonal Basis |
|---|---|---|
| 0 | Horizontal polarization | Diagonal polarization |
| 1 | Vertical polarization | Antidiagonal polarization |

TABLE V
a potential encoding of the polarization of light in degrees
depending on the selected basis (series of modulation) and
the bit value of the message to be sent.

| | Bit selection | |
|---|---|---|
| Basis Selection | 0 | 1 |
| Linear | H: 0 | V: 90 |
| Diagonal | L: 45 | R: 135 |

TABLE VI
the respective probability of measuring a photon
in function of its polarization.

| | | Received polarization | | | |
|---|---|---|---|---|---|
| Transmitted polarization | | H | V | R | L |
| Linear | H | 50 | 0 | 25 | 25 |
| | V | 0 | 50 | 25 | 25 |
| Diagonal | L | 25 | 25 | 0 | 50 |
| | R | 25 | 25 | 50 | 0 |

1. A method of receiving a message encoded in one or more quantum objects from a transmitting quantum device configured to send the message using a receiving quantum device which is configured to receive the message, wherein there is provided between the transmitting and receiving quantum devices a quantum communication channel for transmitting the quantum objects, each of which are readable using one of a plurality of modulations, and wherein there is provided between the receiving quantum device and a quantum device configured to process the message a classical communication channel for transmitting strings of bits, comprising:
using the receiving quantum device, communicating to said quantum device over the classical communication channel an initial series of values selected from a predefined selection space, the initial series of values being representative of an anticipated series of the modulations to be used by said quantum device to process the quantum objects, the anticipated series of the modulations being based on an initial series of values selected by said quantum device from the predefined selection space, wherein the number of the values in the initial series generated by the receiving quantum device corresponds to the number of the quantum objects forming the message and wherein the number of the values in the predefined selection space is at least three;
after communicating the initial series of values, using the receiving quantum device, receiving from said quantum device over the classical communication channel an eliminative series of values representative of a series of values not selected by either said quantum device or the receiving quantum device, the values in the eliminative series being selected from the predefined selection spaced based on a comparison of the initial series of values generated by said quantum device and the initial series of values generated by the receiving quantum device;
using the receiving quantum device, generating a revised series of values selected from a series of reduced selection spaces, each reduced selection space being formed by removing a corresponding one of the values in the eliminative series from the predefined selection space such that each reduced selection space includes at least two values one of which is a corresponding one of the values in the initial series generated by the receiving quantum device and one of which is a corresponding one of the values in the initial series generated by said quantum device, wherein each value in the revised series is selected by either keeping the corresponding value in the initial series generated by the receiving quantum device or changing to a different value in a corresponding reduced selection space in the series of reduced selection spaces;
using the receiving quantum device, determining a receiving series of the modulations to be used to read the quantum objects based on (i) the revised series of values generated by the receiving quantum device, and (ii) the series of reduced selection spaces; and
using the receiving quantum device, receiving over the quantum communication channel the quantum objects from the transmitting quantum device.

2. The method of claim 1 wherein said quantum device is the transmitting quantum device.

3. The method of claim 1 wherein said quantum device is a distinct device configured to receive from the transmitting quantum device a common series of the quantum objects as the receiving quantum device.

4. The method of claim 3 wherein the quantum objects are entangled.

5. The method of claim 1 wherein, in the step of determining the receiving series of the modulations, for each value in the eliminative series designated as a wildcard value by said quantum device, selecting as a corresponding one of the modulations in the receiving series an equally random selection of any one of the modulations such that said corresponding modulation is not based on the revised series of values nor the series of reduced selection spaces.

6. The method of claim 1 further including, before generating the initial series of values, using the receiving quantum device, communicating to said quantum device over the classical communication channel (i) a number of the quantum objects which are to form the message to be transmitted over the quantum communication channel, (ii) a size of the predefined selection space, and (iii) a size of the eliminative series.

7. The method of claim 6 further including, before generating the initial series of values, using the receiving quantum device, communicating to said quantum device over the classical communication channel a revised number of the quantum objects which are to form the message to be transmitted over the quantum communication channel based on a probability received from said quantum device that a value in the eliminative series will be replaced with a wildcard value for which the receiving quantum device is to randomly select any one of the modulations when generating the receiving series of the modulations.

8. The method of claim 1 wherein, in the step of generating the revised series of values, a decision of the receiving quantum device between keeping the corresponding value in the initial series generated by the receiving quantum device, defining a first option, or changing to the different value in a corresponding reduced selection space in the series of reduced selection spaces, defining a second option, is random but has different positive weightings for the first and second options.

9. The method of claim 1 further including, after receiving the quantum objects from the transmitting quantum device, using the receiving quantum device, communicating to said quantum device over the classical communication channel a decision series representative of decisions made by the receiving quantum device when generating the revised series of values to either (i) keep the corresponding value in the initial series generated by the receiving quantum device, or (ii) change to the different value in the corresponding reduced selection space in the series of reduced selection spaces.

10. The method of claim 9 wherein, when the eliminative series generated by said quantum device includes at least one wildcard value such that, in the step of determining the receiving series of the modulations, for each wildcard value, the receiving quantum device selects as a corresponding one of the modulations in the receiving series an equally random selection of any one of the modulations such that said corresponding modulation is not based on the revised series of values nor the series of reduced selection spaces, a corresponding one of the decisions in the decision series that is associated with a respective one of the at least one wildcard value of the eliminative series is the corresponding modulation of the receiving series as determined by the receiving quantum device.

11. The method of claim 1 further including, after receiving the quantum objects from the transmitting quantum device:
using the receiving quantum device, determining a series of probabilities that an eavesdropping quantum device configured to intercept the quantum objects on the quantum communication channel has selected the modulations of the receiving series, each probability of said series of probabilities being based on a corresponding decision made by the receiving quantum device when generating the revised series of values to either (i) keep the corresponding value in the initial series generated by the receiving quantum device, or (ii) change to the different value in the corresponding reduced selection space in the series of reduced selection spaces; and
using the receiving quantum device, assigning, based on the series of probabilities, each of the modulations in the receiving series to one of a plurality of security-levels including (i) strong, where a corresponding probability in the series of probabilities is equal to about 1/n, and (ii) weak, where a corresponding probability in the series of probabilities is equal to about
$$\frac{n - 1}{n \times m} ,$$
where n is the size of the predefined selection space and m is equal to the size of the eliminative series minus one.

12. The method of claim 11 wherein assigning each of the modulations in the receiving series to one of the security levels comprises defining a set of security level series, each of the security level series having a length corresponding to the length of the receiving series of the modulations, the set of security level series including:
a first one of the set of security level series comprising values defined at indices therein that correspond to positions of the modulations in the receiving series assigned to the strong security level, and all other indices in the first security level series are undefined; and
a second one of the set of position-identifying series comprising values defined at indices therein that correspond to positions of the modulations in the receiving series assigned to the weak security level, and all other indices in the second security level series are undefined.

13. The method of claim 11 wherein, when the eliminative series generated by said quantum device includes at least one wildcard value such that, in the step of determining the receiving series of the modulations, for each wildcard value, the receiving quantum device selects as a corresponding one of the modulations in the receiving series an equally random selection of any one of the modulations such that said corresponding modulation is not based on the revised series of values nor the series of reduced selection spaces, a corresponding one of the probabilities in said series of probabilities is between a probability associated with the decision to keep the corresponding value in the initial series generated by the receiving quantum device and a probability associated with the decision to change to the different value in the corresponding reduced selection space in the series of reduced selection spaces; and
wherein assigning the modulations in the receiving series to the security levels further includes assigning each modulation associated with a respective one of said at least one wildcard value to one of the security levels of (iii) neutral, where a corresponding probability in the series of probabilities is equal to one divided by a number of the modulations.

14. The method of claim 13 wherein, when assigning each of the modulations in the receiving series to one of the security levels comprises defining a set of security level series, each of the security level series having a length corresponding to the length of the receiving series of the modulations, the set of security level series further includes a third one of the set of security level series comprising values defined at indices therein that correspond to positions of the randomly selected modulations in the receiving series assigned to the neutral security level, and all other indices in the third security level series are undefined.

15. The method of claim 11 further including, after receiving the quantum objects from the transmitting quantum device:
using the receiving quantum device, receiving from said quantum device over the classical communication channel an accuracy series generated by said quantum device and representative of correspondence between a series of the modulations applied by said quantum device to process the quantum objects of the message and the receiving series of the modulations used by the receiving quantum device to read the quantum objects of the message, the accuracy series being based on a decision series generated by the receiving quantum device and representative of decisions made by the receiving quantum device when generating the revised series of values to either (i) keep the corresponding value in the initial series generated by the receiving quantum device, or (ii) change to the different value in the corresponding reduced selection space in the series of reduced selection spaces;
using the receiving quantum device, cancelling, based on the accuracy series, respective ones from the receiving series of the modulations where there is no correspondence between the series of the modulations applied by said quantum device and the receiving series, so as to generate a revised receiving series containing only the modulations for which there is correspondence between the series of the modulations applied by said quantum device and the receiving series; and
using the receiving quantum device, detecting errors in the message formed by the quantum objects and read by the receiving quantum device using the same modulations applied by said quantum device.

16. The method of claim 15 further including:
using the receiving quantum device, determining a set of error rates associated with the security levels for detecting presence of an eavesdropping quantum device on the quantum communication channel and interpreting a behaviour of an eavesdropping quantum device which is present;
using the receiving quantum device, comparing each of the set of error rates against a prescribed range of error rate associated with a corresponding one of the security levels, each prescribed range of error rate associated with the corresponding security level having a non-zero minimum error rate which is a difference between a natural error rate representative of error due to noise on the quantum communication channel and a prescribed threshold error rate which is associated with the corresponding security level, and the prescribed range of error rates associated with the corresponding security level having a maximum error rate which is a sum of the natural error rate and the prescribed threshold error rate that is associated with the corresponding security level;
using the receiving quantum device, checking if all of the error rates lie within the associated prescribed ranges of error rate, and
if true then determining that there is no eavesdropping quantum device on the quantum communication channel.

17. The method of claim 15 wherein, when a set of error rates associated with the security levels is determined by the receiving quantum device and each of the set of error rates is compared against a prescribed range of error rate associated with a corresponding one of the security levels, each prescribed range of error rate associated with the corresponding security level having a non-zero minimum error rate which is a difference between a natural error rate representative of error due to noise on the quantum communication channel and a prescribed threshold error rate which is associated with the corresponding security level, and the prescribed range of error rates associated with the corresponding security level having a maximum error rate which is a sum of the natural error rate and the prescribed threshold error rate that is associated with the corresponding security level, the method further includes:
using the receiving quantum device, checking if all of the error rates lie below the associated prescribed ranges of error rate, and
if true then determining that there is no eavesdropping quantum device on the quantum communication channel and, for a subsequent message to be sent by the transmitting quantum device, requesting from the said quantum device an increased transmission rate of the message from the transmitting quantum device in which the receiving quantum device decides, at the step of generating the revised series, to more frequently change to the different value instead of keeping the corresponding value in the initial series.

18. The method of claim 15 wherein, when a set of error rates associated with the security levels is determined by the receiving quantum device and each of the set of error rates is compared against a prescribed range of error rate associated with a corresponding one of the security levels, each prescribed range of error rate associated with the corresponding security level having a non-zero minimum error rate which is a difference between a natural error rate representative of error due to noise on the quantum communication channel and a prescribed threshold error rate which is associated with the corresponding security level, and the prescribed range of error rates associated with the corresponding security level having a maximum error rate which is a sum of the natural error rate and the prescribed threshold error rate that is associated with the corresponding security level, the method further includes:
using the receiving quantum device, checking if all of the error rates lie above the associated prescribed ranges of error rate, and
if true then determining that there is an eavesdropping quantum device on the quantum communication channel.

19. The method of claim 18 wherein, if it is determined by the receiving quantum device that there is an eavesdropping quantum device, then the method further includes, using the receiving quantum device, requesting from the said quantum device that a subsequent message to be sent by the transmitting quantum device be based on the initial series generated by the receiving quantum device.

20. The method of claim 18 further including:
using the receiving quantum device, checking if the error rate associated with the strong security level lies above the associated prescribed range of error rate and at least one of the error rate associated with the weak security level and the error rate associated with the neutral security level lies below the maximum error rate of the associated prescribed range of error rate corresponding to said at least one of the weak and neutral security levels, and
if true then determining that the eavesdropping quantum device which is present, and which has already intercepted the quantum objects on the quantum communication channel is strategizing to determine the anticipated series of the modulations to be used by said quantum device for a subsequent message to be sent by the transmitting quantum device by deciding to change respective ones of a first series of the modulations generated by the eavesdropping quantum device in an attempt to substantially match the initial series generated by the receiving quantum device, for subsequently reading the quantum objects intercepted on the quantum communication channel.

21. The method of claim 20 wherein, if it is determined by the receiving quantum device that the eavesdropping quantum device is strategizing to determine the anticipated series by deciding to change respective ones of the first series of the modulations generated by the eavesdropping quantum device, then the method further includes, using the receiving quantum device, discarding the received message based on the read quantum objects.

22. The method of claim 18 further including:
using the receiving quantum device, checking if the error rate associated with the weak security level lies above the associated prescribed range of error rate and at least one of the error rate associated with the strong security level and the error rate associated with the neutral security level lies below the maximum error rate of the associated prescribed range of error rate corresponding to said at least one of the strong and neutral security levels, and
if true then determining that the eavesdropping quantum device which is present, and which has already intercepted the quantum objects on the quantum communication channel, is strategizing to determine the anticipated series of the modulations to be used by said quantum device for a subsequent message to be sent by the transmitting quantum device by deciding to keep respective ones of a first series of the modulations generated by the eavesdropping quantum device in an attempt to substantially match the initial series generated by the receiving quantum device, for subsequently reading the quantum objects intercepted on the quantum communication channel.

23. The method of claim 22 wherein, if it is determined by the receiving quantum device that the eavesdropping quantum device is strategizing to determine the anticipated series by deciding to keep respective ones of the first series of the modulations generated by the eavesdropping quantum device, then the method further includes, using the receiving quantum device, discarding that portion of the message corresponding to the modulations assigned to the weak security level.

24. The method of claim 18 wherein, when the eliminative series generated by said quantum device includes at least one wildcard value such that, in the step of determining the receiving series of the modulations, for each wildcard value, the receiving quantum device selects as a corresponding one of the modulations in the receiving series an equally random selection of any one of the modulations such that said corresponding modulation is not based on the revised series of values nor the series of reduced selection spaces, a corresponding one of the probabilities in said series of probabilities is between a probability associated with the decision to keep the corresponding value in the initial series generated by the receiving quantum device and a probability associated with the decision to change to the different value in the corresponding reduced selection space in the series of reduced selection spaces, and when assigning the modulations in the receiving series to the security levels further includes assigning each modulation associated with a respective one of said at least one wildcard value to one of the security levels of (iii) neutral, where a corresponding probability in the series of probabilities is equal to one divided by a number of the modulations, the method further includes:
using the receiving quantum device, checking if the error rate associated with the strong security level lies below the associated prescribed range of error rate and the error rate associated with the neutral security level lies within the associated prescribed range of error rate, and
if true then determining that the eavesdropping quantum device which is present, and which has already intercepted the quantum objects on the quantum communication channel, is strategizing to determine the anticipated series of the modulations to be used by said quantum device for a subsequent message to be sent by the transmitting quantum device by deciding to keep or choose, from a first series of the modulations generated by the eavesdropping quantum device in an attempt to substantially match the initial series generated by the receiving quantum device, respective ones of the first series corresponding to said at least one wildcard value, for subsequently reading the quantum objects intercepted on the quantum communication channel.

25. The method of claim 24 wherein, if it is determined by the receiving quantum device that the eavesdropping quantum device is strategizing to determine the anticipated series by deciding to keep or chose respective ones of the first series of the modulations corresponding to said at least one wildcard value, then the method further includes, using the receiving quantum device, discarding at least that portion of the message corresponding to the modulations assigned to the weak and neutral security levels.

26. A method of transmitting a message encoded in one or more bits encoded in quantum objects from a transmitting quantum device configured to send the message and a receiving quantum device configured to receive the message, wherein there is provided between the transmitting and receiving quantum devices (i) a quantum communication channel for transmitting the quantum objects, each of which are formed by encoding one or more of the bits of the message using one of a plurality of modulations, and (ii) a classical communication channel for transmitting strings of bits, comprising:
using the transmitting quantum device, generating, by selecting from a predefined selection space, a master series of values representative of the modulations to be used in forming the quantum objects to be transmitted to the receiving quantum device, wherein the number of the values in the master series corresponds to the number of the quantum objects forming the message to be sent and wherein the number of the values in the predefined selection space is at least three;
using the transmitting quantum device, receiving from the receiving quantum device over the classical communication channel an initial series of values selected by the receiving quantum device from the predefined selection space, the values in the initial series being representative of an anticipated series of the modulations to be used by the transmitting quantum device to generate the quantum objects, wherein the number of the values in the initial series corresponds to the number of the quantum objects forming the message to be sent;
using the transmitting quantum device, generating for subsequent communication to the receiving quantum device an eliminative series of values not selected by either the transmitting quantum device or the receiving quantum device, the values in the eliminative series being selected from the predefined selection spaced based on a comparison of the master series of values generated by the transmitting quantum device and the initial series of values received from the receiving quantum device;
wherein, in the step of generating the eliminative series of values, if any pair of the compared values is the same, then the corresponding value in the eliminative series is an equally random selection of any one of the other values from the predefined selection space;
using the transmitting quantum device, communicating the eliminative series of values to the receiving quantum device over the classical communication channel so as to provide a hint to the receiving quantum device as to the master series of values generated by the transmitting quantum device;
using the transmitting quantum device, determining a transmitting series of the modulations to be used to form the quantum objects based on (i) the master series of values generated by the transmitting quantum device, and (ii) a series of reduced selection spaces, each reduced selection space being formed by removing a corresponding one of the values in the eliminative series from the predefined selection space; and
using the transmitting quantum device, communicating to the receiving quantum device over the quantum communication channel the message encoded in the quantum objects formed by the series of the modulations.

27. The method of claim 26 wherein:
the step of generating the eliminative series of values further comprises, for each value in the eliminative series, keeping the value selected from the predefined selection space or replacing said value with a wildcard value; and
in the step of determining the transmitting series of the modulations, for each wildcard value in the eliminative series, selecting as a corresponding one of the modulations in the transmitting series an equally random selection of any one of the modulations such that the corresponding modulator is not based on the master series of values nor the series of reduced selection spaces.

28. The method of claim 27 wherein, in the step of generating the eliminative series of values, a decision of the transmitting quantum device between keeping the value selected from the predefined selection space, defining a first option, or replacing said value with a wildcard value, defining a second option, is random but has different weightings for the first and second options.

29. The method of claim 26 further including, before generating the master series of values, using the transmitting quantum device, communicating to the receiving quantum device over the classical communication channel (i) a number of the quantum objects which are to form the message to be transmitted over the quantum communication channel, and (ii) a size of the predefined selection space.

30. The method of claim 29 further including, before generating the master series of values, using the transmitting quantum device, communicating to the receiving quantum device over the classical communication channel a probability of replacing a value in the eliminative series by a wildcard value for which the receiving quantum device is to random select any one of the modulations when receiving a corresponding one of the quantum objects from the transmitting device.
